(19) United States
(12) Patent Application Publication
(10) Pub. No.: US 2011/0188583 A1
(43) Pub. Date: Aug. 4, 2011

(54) PICTURE SIGNAL CONVERSION SYSTEM

(75) Inventors: Kazuo Toraichi, Ibaraki (JP); Dean Wu, Ibaraki (JP); Jonah Gamba, Ibaraki (JP); Yasuhiro Omiya, Ibaraki (JP)

(73) Assignee: JAPAN SCIENCE AND TECHNOLOGY AGENCY, Saitama, JP (JP)

(21) Appl. No.: 13/061,931

(22) PCT Filed: Jul. 17, 2009
(86) PCT No.: PCT/JP2009/062949

§ 371 Date: Apr. 25, 2011

(30) Foreign Application Priority Data
Sep. 4, 2008 (JP) 2008-227628
Sep. 4, 2008 (JP) 2008-227629
Sep. 4, 2008 (JP) 2008-227630

(51) Int. Cl. H04N 7/64; H04N 7/26

(52) U.S. Cl. 375/240.27; 375/E07.279; 375/E07.193

(57) ABSTRACT

A reverse filter operates for adding noise n(x,y) to an output of a deteriorated model of a blurring function H(x,y) to output an observed model g(x,y). The blurring function inputs a true picture f(x,y) to output a deteriorated picture. The reverse filter recursively optimizes the blurring function H(x,y) so that the input picture signal will be coincident with the observed picture. In this manner, the reverse filter extracts a true picture signal. A corresponding point is estimated, based on a fluency theory, on the true input picture signal freed of noise contained in it by the reverse filter (20). The motion information of a picture is expressed in the form of a function. A plurality of signal spaces is selected by an encoder for compression (30) for the input picture signal. The picture information is expressed by a function from one selected signal space to another. The motion information of the picture expressed by the function and the signal-space-based picture information expressed in the form of a function are expressed in a preset form to encode the picture signal by compression. The picture signal encoded for compression has its frame rate enhanced by a frame rate enhancing processor (40).

### TECHNICAL FIELD

This invention relates to a picture signal conversion system that converts a moving picture into the picture information higher in resolution.

The present Application claims priority rights based on Japanese Patent Applications 2008-227628, 2008-227629 and 2008-227630, filed in Japan on Sep. 4, 2008. These applications of the senior filing date are to be incorporated by reference in the present application.

### BACKGROUND ART

In these days, marked progress has been made in the techniques of digital signals in the multi-media industry or IT (Information Technology) industry, especially the techniques of communication, broadcasting, recording mediums, such as CD (Compact Disc), DVD (Digital Versatile Disc), medical or printing applications handling moving pictures, still pictures or voice. Signal encoding for compression, aimed to decrease the volume of the information, represents a crucial part of the digital signal techniques handling the moving pictures, still images and voice. The encoding for compression is essentially based on the Shannon's sampling theorem as its supporting signal theory and on a more recent theory known as wavelet transform. In music CD, linear PCM (Pulse Code Modulation), not accompanied by compression, is also in use. However, the basic signal theory is again the Shannon's sampling theorem.

Heretofore, MPEG has been known as a compression technique for moving pictures or animation pictures. With the coming into use of the MPEG-2 system in digital broadcast or DVD, as well as the MPEG-4 system in mobile communication or so-called Internet streaming of the third generation mobile phone, the digital compression technique for picture signals has recently become more familiar. The background is the increasing capacity of storage media, increasing speed of the networks, improved processor performance and the increased size of system LSIs as well as low cost. The environment that supports the systems for application in pictures in need of the digital compression is recently more and more in order.

The MPEG2 (ISO (International Organization for Standardization)/IEC (International Electrotechnical Commission) 13818-2) is a system defined as a general-purpose picture encoding system. It is a system defined to cope with both the interlaced scanning and progressive scanning and to cope with both the standard resolution pictures and high resolution pictures. This MPEG2 is now widely used in a broad range of applications including the applications for professional and consumer use. In the MPEG2, standard resolution picture data of 720×480 pixels of the interlaced scanning system may be compressed to pixels of 4 to 8 Mbps bit rate, whilst high resolution picture data of 1920×1080 pixels of the interlaced scanning system may be compressed to pixels of 18 to 22 Mbps bit rate. It is thus possible to assure a high compression rate with a high picture quality.

In encoding moving pictures in general, the information volume is compressed by reducing the redundancy along the time axis and along the spatial axis. In inter-frame predictive coding, motion detection and creation of predictive pictures are made on the block basis as reference is made to forward and backward pictures. It is the difference between the picture as an object of encoding and a predictive picture obtained that is encoded. It should be noted that a picture is a teen that denotes a single picture. Thus, it means a frame in the progressive encoding and a frame or a field in the interlaced scanning. The interlaced picture denotes a picture in which a frame is made up of two fields taken at different time points. In the processing of encoding or decoding the interlaced picture, a sole frame may be processed as a frame per se or as two fields. The frame may also be processed as being of a frame structure from one block in the frame to another, or being of a two-field structure.

Among the techniques of enhancing the quality of a television picture, there is a technique of increasing the number of scanning lines as well as the number of horizontal pixels. For example, video signals of the current NTSC system use 2:1 interlaced scanning, so that the vertical resolution is approximately 300 lines. The number of scanning lines of a display device used in a routine television receiver is 525. It is noted that the resolution is deteriorated by the interlaced scanning. To cope with this problem, there is known a technique of increasing the number of pixels in the vertical direction by field interpolation using a field buffer to convert the scanning into non-interlaced scanning to enhance the resolution in the vertical direction.

In certain display devices used for a high quality television receiver, the number of vertical pixels is set to twice as many as that for a routine television receiver. According to this technique, the horizontal resolution may be increased by doubling the number of pixels in the direction of the scanning lines, thereby enhancing the horizontal resolution.

There are currently known methods of repeating or decimating the same pixels at a preset interval to enlarge or reduce a picture by a simplified processing. Viz., such techniques for reducing picture distortion ascribable to errors at a reduced volume of mathematical operations, or such techniques for encoding picture data more efficiently, have so far been proposed. See for example the Japanese Laid-Open Patent Publications Hei 11-353472, 2000-308021 and 2008-4984.

There is also proposed a technique in which accurate camera moving components of sub-pixels between pixels are detected at the same time as moving pixels are input to decide on larger numbers of the sub-pixels and combining the pixels into a picture by e.g., an infinite impulse response (IIR) filter. By so doing, the resolution may be improved to achieve high picture quality by picture enhancement by electronic zooming. See for example the Japanese Laid-Open Patent Publication Hei 9-163216.

Moreover, to adaptively remove non-clear portions due to handshake, defocusing or smoke in video signal capturing, the processing by frame-to-frame differential information or the processing by a Wiener filter has so far been used.

For example, to remove the imaging noise in an image picked up by a camera capable of performing a rotational movement or a zooming movement, by a remote operation, a feedback coefficient representing the amount of feedback of a picture of a directly previous frame to a picture of the current frame is found. The picture of such previous frame is superposed on the frame of the current frame with a ratio corresponding to the feedback amount. It is then calculated where in a picture image of the directly previous frame a picture signal of interest in the current frame was located. These calculations are to be based on the rotation information regarding the rotation of a video camera system in question and/or the zooming information for the zooming operation. If the picture portions for the same objects are correctly superimposed together, it is possible to reduce after-image feeling based on processing for removing image capturing noise otherwise caused by rotational and/or zooming movements. See for example, the Japanese Laid-Open Patent Publication 2007-134886.

There has also been proposed a picture noise removing circuit in which the presence or non-presence of the noise in a plurality of picture signal for the same object is detected to output at least one noise-free picture signal. See for example the Japanese Laid-Open Patent Publication Hei 8-84274.

### DISCLOSURE OF THE INVENTION

### Problem to be Solved by the Invention

A conventional A-D conversion/D-A conversion system, which is based on the Shannon's sampling theorem, handles a signal band-width-limited by the Nyquist frequency. In this case, to convert a signal, turned into discrete signals by sampling, back into a time-continuous signal, a function that recreates a signal within the limited frequency range (regular function) is used in D-A conversion.

One of the present inventors has found that various properties of the picture signal or the voice signal, such as a picture (moving picture), letters, figures or a picture of natural scenery, may be classified using a fluency function. According to the corresponding theory, the above mentioned regular function, which is based on the Shannon's sampling theorem, is among the fluency functions, and simply fits with a sole signal property out of a variety of signal properties. Thus, if the large variety of the signals are treated with only the regular function which is based upon the Shannon's sampling theorem, there is a fear that restrictions are imposed on the quality of the playback signals obtained after D/A conversion.

The theory of wavelet transform represents a signal using a mother wavelet that decomposes an object in terms of the resolution. However, since a mother wavelet optimum to a signal of interest is not necessarily available, there is again a fear that restrictions are imposed on the quality of the playback signals obtained on D/A conversion.

The fluency function is a function classified by a parameter in, m being a positive integer of from 1 to ∞. It is noted that m denotes that the function is continuously differentiable only by (m−2) times. Since the above regular function is differentiable any number of times, m=∞. Moreover, the fluency function is constituted by a degree (m−1) function. In particular, the fluency DA function, out of a variety of the fluency functions, has its value determined by a k'th sampling point kτ of interest, where i is the sample interval. At the other sampling points, the function becomes zero (0).

The total of the properties of a signal may be classified by a fluency function having a parameter in, which parameter in determines the classes. Hence, the fluency information theory, making use of the fluency function, comprehends the Shannon's sampling theorem or the theory of wavelet transform each of which simply represent a part of the signal properties. Viz., the fluency information theory may be defined as a theory system representing a signal in its entirety. By using such function, a high quality playback signal, not bandwidth-limited by the Shannon's sampling theorem, may be expected to be obtained on D-A conversion for the entire signal.

Meanwhile, in the conventional processing by frame-to-frame differential information or by a Wiener filter, it is not possible to render a picture clearer or to emphasize an edge.

On the other hand, in contents communication or picture retrieval, it is required to display a clear picture which performs a smooth movement.

However, a digital picture suffers a problem that step-shaped irregularities, called jaggies, are produced at an edge of a partial picture on picture enlarging to a higher multiplication factor, thereby deteriorating the picture quality. For example, in MPEG, known as a compression technique for moving pictures or animation pictures, such jaggies are produced at a picture contour to deteriorate the sharpness or to deteriorate color reproducing performance in the boundary region between dense and pale color portions.

As regards the frame-to-frame information, simply the information on interpolation is exploited, however, no high definition information is produced.

On the other hand, frame rate conversion has been recognized to be necessary to meet the demand for converting the overseas video information or motion pictures into the video information or for interpolating the frame-to-frame information in animation picture creation. For example, a need is felt for converting a picture of the motion picture signal system at a rate of 24 frames per second into a picture at a rate of 30 frames per second or for converting the picture rate of a television picture to a higher frame rate for enhancing the definition or into pictures of a frame rate for mobile phones.

However, such a method that generates a new frame by frame decimation or by interpolation of forward and backward picture frames has so far been a mainstream method. There has thus been raised a problem that the picture motion is not smooth or the picture becomes distorted.

In view of the above described problems of the related technology, it is desirable to provide a picture signal conversion system according to which the moving picture information such as picture or animation may be processed in a unified manner to enable generation of a high quality moving picture.

It is desirable to provide a picture signal conversion system having a filtering function of removing noise from the video signal to yield a clear picture with emphasized edges.

It is desirable to provide a picture signal conversion system that allows a clear picture performing a smooth motion to be displayed and that has the moving picture processing function effective for contents communication or for picture retrieval.

Other advantages of the present invention will become more apparent from the following description of preferred embodiments of the invention.

A picture signal conversion system according to an embodiment of the present invention comprises a pre-processor having a reverse filter operating for performing pre-processing of removing blurring or noise contained in an input picture signal. The pre-processor includes an input picture observation model that adds noise n(x,y) to an output of a bluffing function H(x,y) to output an observed model g(x,y), the blurring function inputting a true picture f(x,y) to output a deteriorated picture. The pre-processor recursively optimizes the blurring function H(x,y) so that the input picture signal will be coincident with the observed picture. The reverse filter extracts a true picture signal from the input picture signal. The picture signal conversion system also comprises an encoding processor performing corresponding point estimation, based on a fluency theory, on the true input picture signal freed of noise by the pre-processor. The encoding processor expresses the motion information of a picture in the form of a function and selects a signal space for the true input picture signal. The encoding processor also expresses the picture information for an input picture signal from one selected signal space to another, and states the picture motion information expressed in the form of a function and the picture information of the picture expressed as the function in a preset form such as to encode the picture signal by compression. The picture signal conversion system also comprises a frame rate enhancing processor for enhancing the frame rate of the picture signal encoded for compression by the encoding processor.

In the picture signal conversion system according to the embodiment of the present invention, the encoding processor comprises a corresponding point estimation unit for performing corresponding point estimation on the input picture signal freed of noise by the pre-processor based on the fluency theory. The encoding processor also comprises a first render-into-function processor for expressing the picture movement information in the form of a function based on the result of estimation of the corresponding point information by the corresponding point estimation unit. The encoding processor also comprises a second render-into-function processor for selecting a plurality of signal spaces for the input picture signal and for putting the picture information in the form of a function from one signal space selected to another. The encoding processor further comprises an encoding processor that states the picture movement information expressed in the form of the function by the first render-into-function processor, and the picture information for each signal space expressed as a function by the second render-into-function, in a preset form, such as to encode the input picture signal by compression.

In the picture signal conversion system according to the embodiment of the present invention, the corresponding point estimation unit comprises first partial region extraction means for extracting a partial region of a frame picture, and second partial region extraction means for extracting a partial region of another frame picture similar in shape to the partial region extracted by the first partial region extraction means. The corresponding point estimation unit also comprises approximate-by-function means for selecting the partial regions extracted by the first and second partial region extraction means so that the selected partial regions will have equivalent picture states. The approximate-by-function means expresses the gray levels of the selected partial regions by piece-wise polynomials to output the piece-wise polynomials. The corresponding point estimation unit further comprises correlation value calculation means for calculating correlation values of outputs of the approximate-by-function means, and offset value calculation means for calculating the position offset of the partial regions that will give a maximum value of the correlation calculated by the correlation value calculation means to output the calculated values as the offset values of the corresponding points.

In the picture signal conversion system according to the embodiment of the present invention, the second render-into-function processor includes an automatic region classification processor that selects a plurality of signal spaces, based on the fluency theory, for the picture signal freed of noise by the pre-processing. The second render-into-function processor also includes a render-into-function processing section that renders the picture information into a function from one signal space selected by the automatic region classification processor to another. The render-into-function processing section includes a render-gray-level-into-function processor that, for a region that has been selected by the automatic region classification processor and that is expressible by a polynomial, approximates the picture gray level by approximation with a surface function to put the gray level information into the form of a function. The render-into-function processing section also includes a render-contour-line-into-function processor that, for the region that has been selected by the automatic region classification processor and that is expressible by a polynomial, approximates the picture contour line by approximation with the picture contour line function to render the contour line into the form of a function.

In the picture signal conversion system according to the embodiment of the present invention, the render-gray-level-into-function processor puts the gray level information, for the picture information of the piece-wise curved surface information (m=3), piece-wise spherical surface information (m=∞) and piece-wise planar information, selected by the automatic region classification processor and expressible by a polynomial (m≦2), using a fluency function.

In the picture signal conversion system according to the embodiment of the present invention, the render-contour-line-into-function processor includes an automatic contour classification processor that extracts and classifies the piece-wise line segment, piece-wise degree-two curve and piece-wise arc from the picture information selected by the automatic region classification processor. The render-contour-line-into-function approximates the piece-wise line segment, piece-wise degree-two curve and the piece-wise arc, classified by the render-contour-line-into-function processor, using fluency functions, to put the contour information into the form of a function.

In the picture signal conversion system according to the embodiment of the present invention, the frame rate enhancing unit includes a corresponding point estimation processor that, for each of a plurality of pixels in a reference frame, estimates a corresponding point in each of a plurality of picture frames differing in time. The frame rate enhancing unit also includes a first processor of gray scale value generation that, for each of the corresponding points in each picture frame estimated, finds the gray scale value of each corresponding point from gray scale values indicating the gray level of neighboring pixels. The frame rate enhancing unit also includes a second processor of gray scale value generation that approximates, for each of the pixels in the reference frame, from the gray scale values of the corresponding points in the picture frames estimated, the gray scale value of the locus of the corresponding points by a fluency function, and that finds, from the function, the gray scale values of the corresponding points of a frame for interpolation. The frame rate enhancing unit further includes a third processor of gray scale value generation that generates, from the gray scale value of each corresponding point in the picture frame for interpolation, the gray scale value of neighboring pixels of each corresponding point in the frame for interpolation.

In the picture signal conversion device according to the embodiment of the present invention, the frame rate enhancing processor performs, for the picture signal encoded for compression by the encoding processor, the processing of enhancing the frame rate as well size conversion of enlarging or reducing the picture size to a predetermined size, based on the picture information and the motion information put into the form of the functions.

The present invention also provides a picture signal conversion device, wherein the frame rate enhancing unit includes first function approximation means for inputting the picture information, encoded for compression by the encoding processor, and for approximating the gray scale distribution of a plurality of pixels in reference frames by a function. The frame rate enhancing unit also includes corresponding point estimation means for performing correlation calculations using a function of gray scale distribution in a reference frame, approximated by the first approximate-by-function unit, in a plurality of the reference frames differing in time, and for setting respective positions that yield the maximum value of the correlation as the corresponding point positions in the respective reference frames. The frame rate enhancing unit also includes second function approximation means for putting corresponding point positions in each reference frame as estimated by the corresponding point estimation unit into the form of coordinates in terms of the horizontal and vertical distances from the point of origin of each reference frame, converting changes in the horizontal and vertical positions of the coordinate points in the reference frames different in time into time-series signals, and for approximating the time-series signals of the reference frames by a function. The frame rate enhancing unit further includes a third approximate-by-function unit for setting, for a picture frame of interpolation at an optional time point between the reference frames, a position in the picture frame for interpolation corresponding to the corresponding point positions in the reference frames, as a corresponding point position, using the function approximated by the second approximate-by-function unit. The third approximate-by-function unit finds a gray scale value at the corresponding point position of the picture frame for interpolation by interpolation with gray scale values at the corresponding points of the reference frames. The third approximate-by-function unit causes the first function approximation to fit with the gray scale value of the corresponding point of the picture frame for interpolation to find the gray scale distribution in the neighborhood of the corresponding point to convert the gray scale distribution in the neighborhood of the corresponding point into the gray scale values of the pixel points in the picture frame for interpolation.

In the picture signal conversion system according to the embodiment of the present invention, if f(x,y)*f(x,y) is representatively expressed as Hf, from the result of singular value decomposition (SVD) on an observed picture g(x,y) and a blurring function of a deteriorated model, the reverse filter in the pre-processor possesses filter characteristics obtained on learning of repeatedly performing the processing of setting a system equation as

g=f+Hf+n [Equation 1]

approximating f as

H=A [symbol] B

(A [symbol] B)f=vec(BFA^{T}), vec(F)=f [Equation 2]

(where

[symbol]

[Equation 3]

denotes a Kronecker operator, and

vec [Equation 4]

is an operator that extends a matrix in the column direction to generate a column vector);
calculating a new target picture g_{E} as

g_{E}=(βC_{EP}+γC_{EN})g [Equation 5]

(where β, γ are control parameters and C_{EP}, C_{EN} are respectively operators for edge saving and edge emphasis) and as

g_{KPA}=vec(BG_{E}A^{T}), vec(G_{E})=g_{E} [Equation 6]

performing minimizing processing

$${min}_{f} \{ {‖ {H}_{k} f - {g}_{KPA} ‖}^{2} + α {‖ Cf ‖}^{2} \} \qquad [ Equation 7 ]$$

on the new picture calculated g_{KPA}, verifying whether or not the test condition is met; if the test condition is not met, performing minimizing processing:

$${min}_{H} \{ {‖ {Hf}_{k} - {g}_{KPA} ‖}^{2} \} \qquad [ Equation 8 ]$$

on the blurring function Hₖ of the deterioration model, and estimating the blurring function H of the deterioration model as

G_{SVD}=UΣV^{T}, A=U_{A}Σ_{A}V_{A}^{T}, B=U_{B}Σ_{B}V_{B}^{T} [Equation 9]

until fₖ obtained by the minimizing processing on the new picture g_{KPA} meets the test condition.

H=(U_{A} [symbol] U_{B})(Σ_{A} [symbol] Σ_{B})(V_{A} [symbol] V_{B})^{T} [Equation 10]

In the picture signal conversion device according to the embodiment of the present invention, the processing for learning verifies whether or not, on fₖ obtained by the minimizing processing on the new picture calculated g_{KPA}, the test condition:

H=(U_{A} [symbol] U_{B})(Σ_{A} [symbol] Σ_{B})(V_{A} [symbol] V_{B})^{T} [Equation 11]

where k is the number of times of repetition and E, c denote threshold values for decision, is met.

### BRIEF DESCRIPTION OF THE DRAWINGS

FIG. 1 is a block diagram showing the configuration of a picture signal conversion system according to the embodiment of the present invention.

FIG. 2 is a block diagram showing a system model used for constructing a pre-processor in the picture signal conversion system.

FIG. 3 is a block diagram showing a restoration system model used for constructing the preprocessor in the picture signal conversion system.

FIG. 4 is a flowchart showing a sequence of each processing of a characteristic of a reverse filter used in the pre-processor.

FIG. 5 is a block diagram showing the configuration of a compression encoding processor in the picture signal conversion system.

FIG. 6 is a block diagram showing the configuration of a corresponding point estimation unit provided in the compression encoding processor.

FIG. 7 is a graph for illustrating the space in which to perform 2m-degree interpolation to which the inter-frame-to-frame correlation function belongs.

FIGS. 8A to 8D are schematic views showing the manner of determining the motion vector by corresponding point estimation by the corresponding point estimation unit.

FIG. 9 is a schematic view for comparing the motion vector as determined by the corresponding point estimation by the corresponding point estimation unit to the motion vector as determined by conventional block matching.

FIG. 10 is a schematic view for illustrating the point of origin of a frame picture treated by a motion function processor provided in the compression encoding processor.

FIGS. 11A to 11C are schematic views showing the motion of pictures of respective frames as motions of X- and Y-coordinates of the respective frames.

FIG. 12 is a graph for illustrating the contents of the processing of estimating the inter-frame position.

FIGS. 13A and 13B are diagrammatic views showing example configurations of a picture data stream generated by MPEG coding and a picture data stream generated by an encoding processor in the picture signal conversion system.

FIG. 14 is a diagrammatic view showing an example bit format of I- and P-pictures in a video data stream generated by the encoding processor.

FIG. 15 is a diagrammatic view showing an example bit format of a D-picture in the video data stream generated by the encoding processor.

FIGS. 16A and 16B are graphs showing transitions of X- and Y-coordinates of corresponding points in the example bit format of the D-picture.

FIG. 17 is a graph schematically showing an example of calculating the X-coordinate values of each D-picture in a corresponding region from X-coordinate values of forward and backward pictures.

FIG. 18 is a block diagram showing an example formulation of a frame rate conversion device.

FIGS. 19 A and 19B are schematic views showing the processing for enhancing the frame rate by the frame rate conversion device.

FIG. 20 is a flowchart showing the sequence of operations for executing the processing for enhancing the frame rate by the frame rate conversion device.

FIGS. 21A to 21D are schematic views for illustrating the contents of the processing for enhancing the frame rate carried out by the frame rate conversion device.

FIG. 22 is a schematic view for illustrating the non-uniform interpolation in the above mentioned frame rate conversion.

FIG. 23 is a graph for illustrating the processing of picture interpolation that determines the value of the position of a pixel newly generated at the time of converting the picture resolution.

FIGS. 24A and 24B are graphs showing examples of a uniform interpolation function and a non-uniform interpolation function, respectively.

FIG. 25 is a schematic view for illustrating the contents of the processing for picture interpolation.

FIG. 26 is a block diagram showing an example configuration of the enlarging interpolation processor.

FIG. 27 is a block diagram showing an example configuration of an SRAM selector of the enlarging interpolation processor.

FIG. 28 is a block diagram showing an example configuration of a picture processing block of the enlarging interpolation processor.

FIGS. 29A and 29B are schematic views showing two frame pictures entered to a picture processing module in the enlarging interpolation processor.

FIG. 30 is a flowchart showing the sequence of operations of enlarging interpolation by the enlarging interpolation processor.

FIG. 31 is a block diagram showing an example configuration of the frame rate conversion device having the function of the processing for enlarging interpolation.

FIG. 32 is a graph showing a class (m=3) non-uniform fluency interpolation function.

FIG. 33 is a set of graphs showing examples of approach of high resolution interpolation.

FIG. 34 is a schematic view showing a concrete example of a pixel structure for interpolation.

FIGS. 35(A), (B1), (C1), (B2), (C2) are schematic views for comparing intermediate frames generated by the above frame rate enhancing processing to intermediate frames generated by the conventional technique, wherein FIGS. 35(A), (B1), (C1) show an example of conventional ca. ½ precision motion estimation and FIGS. 35(A), (B2), (C2) show an example of non-uniform interpolation.

### BEST MODE FOR CARRYING OUT THE INVENTION

Preferred embodiments of the present invention will now be described with reference to the drawings. It should be noted that the present invention is not to be limited to the embodiments as now described and may be altered as appropriate within the range not departing from the scope of the invention.

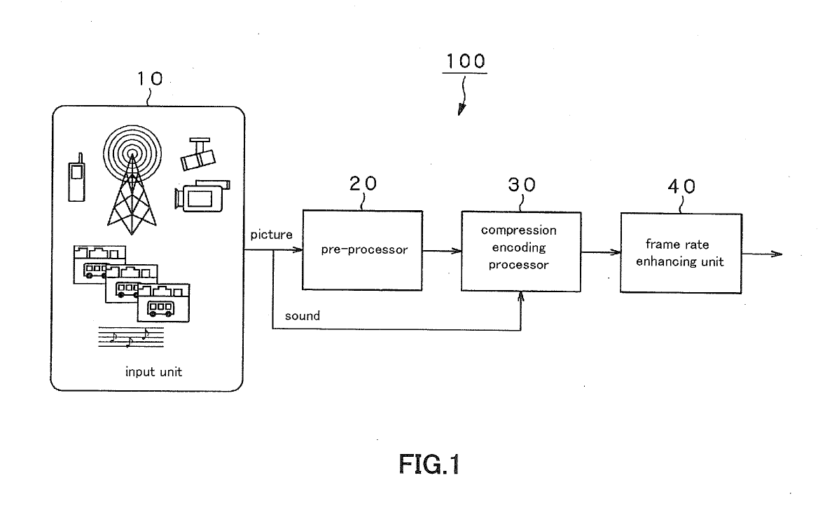

The present invention is applied to a picture signal conversion system 100, configured as shown for example in FIG. 1 .

The picture signal conversion system 100 includes a pre-processor 20 that removes noise from the picture information entered from a picture input unit 10, such as an image pickup device, a compression encoding processor 30 and a frame rate enhancing unit 40. The compression encoding processor 30 inputs the picture information freed of noise by the pre-processor 20 and encodes the input picture information by way of compression. The frame rate enhancing unit 40 enhances the frame rate of the picture information encoded for compression by the compression encoding processor 30.

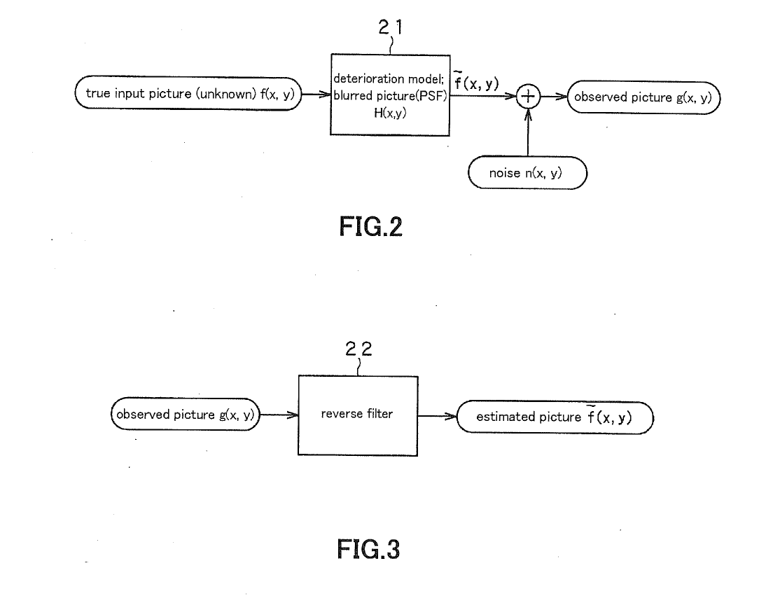

The pre-processor 20 in the present picture signal conversion system 100 removes the noise, such as blurring or hand-shake noise, contained in the input picture information, based on the technique of picture tensor calculations and on the technique of adaptive correction processing by a blurring function, by way of performing filtering processing. By a system model shown in FIG. 2, an output of a deterioration model 21 of a blurring function H (x, y) that receives a true input picture f(x, y):

\hat{f}(x,y) [Equation 12]

is added to with a noise n (x, y) to produce an observed picture g(x, y). The input picture signal is entered to a restoration system model, shown in FIG. 3, to adaptively correct the model into coincidence with the observed picture g(x, y) to obtain an estimated picture:

\hat{f}(x,y) [Equation 13]

as a true input picture signal. The pre-processor 20 is, in effect, a reverse filter 22.

The pre-processor 20 removes the noise based on the technique of picture tensor calculations and on the technique of adaptive correction processing of a blurring function, by way of performing the filtering, and evaluates the original picture using the characteristic of a Kronecker product.

The Kronecker product is defined as follows:

If A=[a₁₁] is a mn matrix and B=[b₁₁] is an st matrix, the Kronecker product

(A [symbol] B) [Equation 14]

is the following ms×nt matrix:

A [symbol] B=[aᵢⱼB] [Equation 15]

where

[symbol]

[Equation 16]

denotes a Kronecker product operator.

The basic properties of the Kronecker product are as follows:

(A [symbol] B)^{T}=A^{T} [symbol] B^{T}

(A [symbol] B)(C [symbol] D)=(AC) [symbol] (BD)

(A [symbol] B)x=vec(BXA^{T}), vec(X)=x,

(A [symbol] B)vec(X)=vec(BXA^{T}) [Equation 17]

where

vec [Equation 18]

is an operator that represents the operation of extending the matrix in the column direction to generate a column vector.

In the picture model in the pre-processor 20, it is supposed that there exists an unknown true input picture f(x, y). The observed picture g(x, y), obtained on adding the noise n(x, y) to an output of the deterioration model 21:

\hat{f}(x,y) [Equation 19]

may be represented by the following equation (1):

[Equation 20]

g(x,y)= f̅(x,y)+n(x,y) (1)

where

\hat{f}(x,y) [equation 21]

represents a deteriorated picture obtained with the present picture system, and n(x, y) is an added noise. The deteriorated picture:

\hat{f}(x,y) [equation 22]

is represented by the following equation (2):

[equation 23]

\hat{f}(x,y)=∫∫h(x,y;x′,y′)f(x′,y′)dx′dy′ (2)

where h(x, y; x′, y′) represents an impulse response of the deterioration system.

Since the picture used is of discrete values, a picture model of the input picture f(x, y) may be rewritten as indicated by the following equation (3):

$$\begin{matrix}[ equation 24 ] & \\ f ( x , y ) = {\sum }_{k , l} \hat{f} ( k , l ) φ ( x - k , y - l ) & ( 3 ) \\ \begin{matrix}\tilde{f} ( i , j ) = \int \int h ( i , j ; {x}^{′} , {y}^{′} ) f ( {x}^{′} , {y}^{′} ) d {x}^{′} d {y}^{′} \\ = \int \int h ( i , j ; {x}^{′} , {y}^{′} ) {\sum }_{k , l} \hat{f} ( k , l ) φ ( {x}^{′} - k , {y}^{′} - l ) d {x}^{′} d {y}^{′} \\ = {\sum }_{k , l} \hat{f} ( k , l ) \int \int h ( i , j ; {x}^{′} , {y}^{′} ) φ ( {x}^{′} - k , {y}^{′} - l ) d {x}^{′} d {y}^{′} \\ = {\sum }_{k , l} \hat{f} ( k , l ) {H}_{k}^{( x )} {H}_{l}^{( y )}\end{matrix} & \end{matrix}$$

where Hₖ₍ₓ₎, H_{l(y)}, expressed in a matrix form as indicated by the following equation (4), becomes a point image intensity distribution function of the deterioration model (PSF: Point Spread Function) H.

[equation 25]

H=[Hₖ^{(x)}Hₗ^{(y)}] (4)

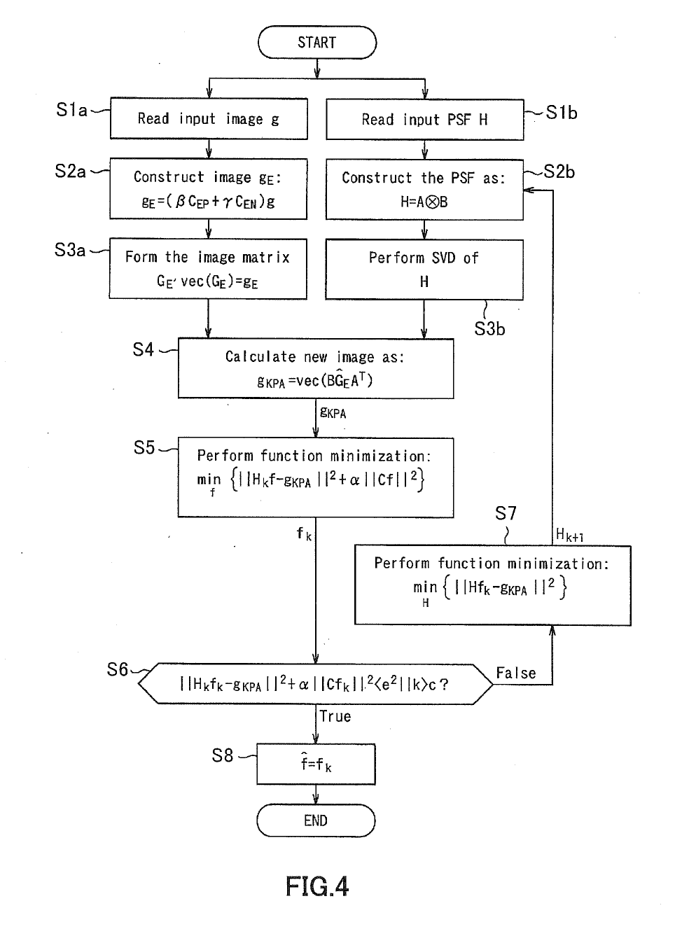

The above described characteristic of the reverse filter 22 is determined by the processing of learning as carried out in accordance with the sequence shown in the flowchart of FIG. 4.

Viz., in the processing of learning, the input picture g is initially read-in as the observed image g(x, y) (step S1a) to construct the picture g_{E} as:

g_{E}=(βC_{EP}+γC_{EN})g [equation 26]

at step S2a
to carry out the singular value decomposition (SVD) of

G_{E},vec(G_{E})=g_{E} [equation 27]

in step S3(a).

The point spread function (PSF) H of the deterioration model is then read-in (step S1b) to construct

a deterioration model represented by the Kronecker product:

H=(A [symbol] B) [equation 28]

at step S2b to carry out the singular value decomposition (SVD) of the above mentioned deterioration model function H (step S3b).

The system equation g may be rewritten to:

g=(A [symbol] B)f=vec(BEA^{T}), vec(F)=f [equation 29]

A new picture g_{KPA} is calculated (step S4) as

g_{KPA}=vec(BĜ_{E}A^{T}) [equation 30]

The minimizing processing of

$${min}_{f} \{ {‖ {H}_{k} f - {g}_{KPA} ‖}^{2} + α {‖ Cf ‖}^{2} \} \qquad [ e quation 31 ]$$

is carried out on the new picture g_{KpA} calculated (step S5). It is then checked whether or not f_{K} as obtained meets the test condition:

∥Hₖfₖ−g_{KPA}∥²+α∥Cfₖ∥²<ε², k>c [equation 32]

at step S6. In the above equation, k is a number of times of repetition and g, c represent threshold values for decision (step S6).

If the result of decision in the step S6 is False, viz., f_{K} obtained in the step S5 has failed to meet the above test condition, the minimizing processing:

$${min}_{H} \{ {‖ {Hf}_{k} - {g}_{KPA} ‖}^{2} \} \qquad [ e quation 33 ]$$

is carried out on the above mentioned function H of the deterioration model (step S7) to revert to the above step S3b. On the function Hₖ₊₁, obtained by the above step S6, singular value decomposition (SVD) is carried out. The processing as from the step S3b to the step S7 is reiterated. When the result of decision in the step S6 is True, that is, when f_{K} obtained in the above step 5 meets the above test condition, f_{K} obtained in the above step S5 is set to

\hat{f}=fₖ [equation 34]

(step S8) to terminate the processing of learning for the input picture g.

The characteristic of the reverse filter 22 is determined by carrying out the above mentioned processing of learning on larger numbers of input pictures g.

Viz., h(x, y)*f(x, y) is representatively expressed by Hf, and the system equation is set to

g=f+n=Hf+n [equation 35]

and to

H=A [symbol] B

(A [symbol] B)f=vec(BEA^{T}), vec(F)=f [equation 36]

to approximate f to derive the targeted new picture g_{E} as follows:

g_{E}=E[f] [equation 37]

where E stands for estimation. The new picture g_{E} is constructed for saving or emphasizing edge details of an original picture.

The new picture g_{E} is obtained as

g_{E}=(βC_{EP}+γC_{EN})g [equation 38]

where C_{EP} and C_{EN} denote operators for edge saving and edge emphasis, respectively.

A simple Laplacian kernel C_{EP}=∇₂F and a Gaussian kernel C_{EN} having control parameters β and γ, are selected to set

g_{KPA}=vec(BG_{E}A^{T}), vec(G_{E})=g_{E} [equation 39]

A problem of minimization is re-constructed as

M(α,f)=∥Hf−g_{KPA}∥²+α∥Cf∥² [equation 40]

and, from the following singular value decomposition (SVD):

G_{SVD}=UΣV^{T}, A=U_{A}Σ_{A}V_{A}^{T}, B=U_{B}Σ_{B}V_{B}^{T} [Equation 41]

the function H of the above deterioration model is estimated as

H=(U_{A} [symbol] U_{B}(Σ_{A} [symbol] Σ_{B})(V_{A} [symbol] V_{B})^{T} [Equation 42]

which is used.

Bt removing the noise, such as blurring or hand-shake noise, contained in the input picture information, based on the technique of picture tensor calculations and on the technique of adaptive correction processing of a blurring function, by the filtering processing, as in the pre-processor 20 in the present picture signal conversion system 100, it is possible not only to remove the noise but to make the picture clear as well as to emphasize the edge.

In the present picture signal conversion system 100, the picture information, processed for noise removal by the pre-processor 20, is encoded for compression by the compression encoding processor 30. In addition, the picture information, encoded for compression, has the frame rate enhanced by the frame rate enhancing unit 40.

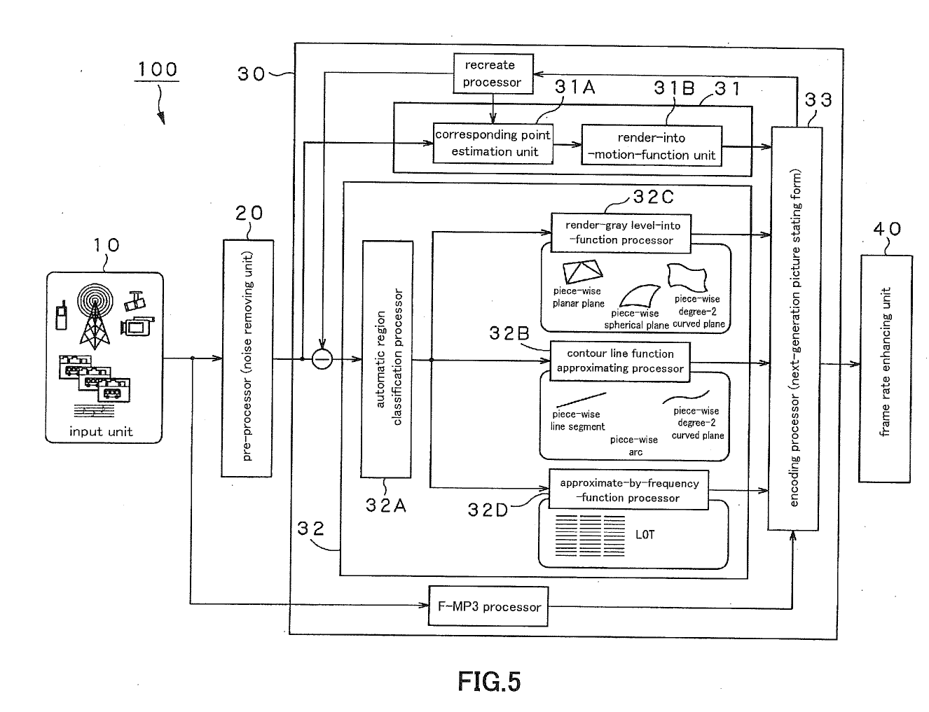

The compression encoding processor 30 in the present picture signal conversion system 100 performs the encoding for compression based on the theory of fluency. Referring to FIG. 5, the compression encoding processor includes a first render-into-function processor 31, a second render-into-function processor 32, and an encoding processor 33. The encoding processor 33 states each picture information, put into the form of a function by the first render-into-function processor 31 and the second render-into-function processor 32, in a predetermined form by way of encoding.

The first render-into-function processor 31 includes a corresponding point estimation unit 31A and a render-motion-into-function processor 31B. The corresponding point estimation unit 31A estimates corresponding points between a plurality of frame pictures for the picture information that has already been freed of noise by the pre-processor 20. The render-motion-into-function processor 31B renders the moving portion of the picture information into the form of a function using the picture information of the corresponding points of the respective frame pictures as estimated by the corresponding point estimation unit 31A.

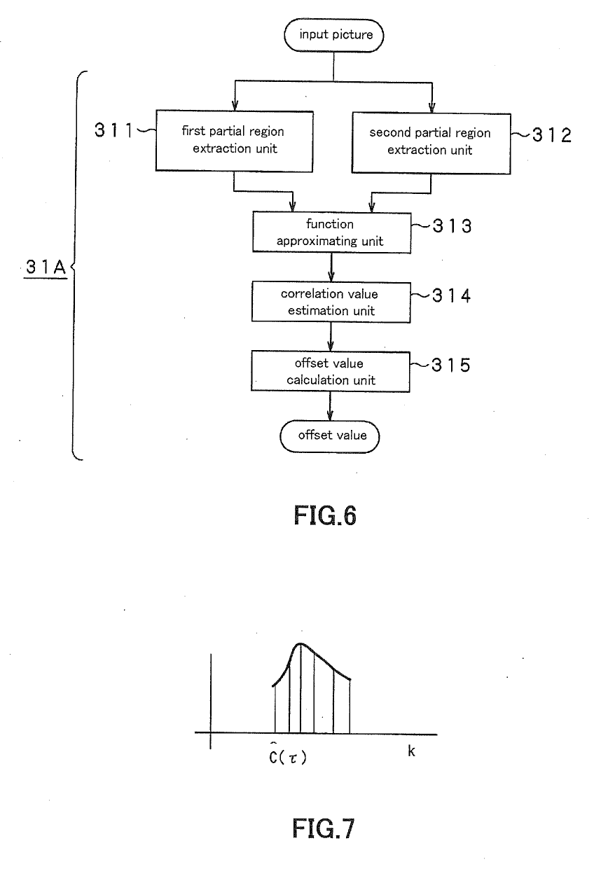

The corresponding point estimation unit 31A is designed and constructed as shown for example in FIG. 6.

Viz., the corresponding point estimation unit 31A includes a first partial picture region extraction unit 311 that extracts a partial picture region of a frame picture. The corresponding point estimation unit 31A also includes a second partial picture region extraction unit 312 that extracts a partial picture region of another frame picture that is consecutive to the first stated frame picture. The partial picture region extracted is to be similar in shape to the partial picture region extracted by the first partial picture region extraction unit 311. The corresponding point estimation unit also includes an approximate-by-function unit 313 that selects the partial picture regions, extracted by the first and second partial picture region extraction units 311, 312, so that the two partial picture regions extracted will be in the same picture state. The approximate-by-function unit 313 expresses the gray scale values of the so selected partial picture regions in the form of a function by a piece-wise polynomial in accordance with the fluency function to output the resulting functions. The corresponding point estimation unit also includes a correlation value calculation unit 314 that calculates the correlation value of the output of the approximate-by-function unit 313. The corresponding point estimation unit further includes an offset value calculation unit 315 that calculates the picture position offset that will give a maximum value of correlation as calculated by the correlation value calculation unit 314 to output the result as an offset value of the corresponding point.

In this corresponding point estimation unit 31A, the first partial picture region extraction unit 311 extracts the partial picture region of the frame picture as a template. The second partial picture region extraction unit 312 extracts partial picture region of another frame picture which is consecutive to the first stated frame picture. The partial picture regions is to be similar in shape to the partial picture region extracted by the first partial picture region extraction unit 311. The approximate-by-function unit 313 selects the partial picture regions, extracted by the first and second partial picture region extraction units 311, 312, so that the two partial picture regions will be in the same picture state. The approximate-by-function unit expresses the gray scale value of each converted picture in the form of a function by a piece-wise polynomial.

The corresponding point estimation unit 31A captures the gray scale values of the picture as continuously changing states and estimates the corresponding points of the picture in accordance with the theory of the fluency information. The corresponding point estimation unit 31A includes the first partial picture region extraction unit 311, second partial picture region extraction unit 312, function approximating unit 313, correlation value estimation unit 314 and the offset value calculation unit 315.

In the corresponding point estimation unit 31A, the first partial picture region extraction unit 311 extracts a partial picture region of a frame picture.

The second partial picture region extraction unit 312 extracts a partial picture region of another frame picture which is consecutive to the first stated frame picture. This partial picture region is to be similar in shape to the partial picture region extracted by the first partial picture region extraction unit 311.

The function approximating unit 313 selects the partial picture regions, extracted by the first and second partial picture region extraction units 311, 312, so that the two partial picture regions extracted will be in the same picture state. In addition, the function approximating unit 313 expresses the gray scale value of each converted picture in the form of a function by a piece-wise polynomial in accordance with the fluency theory, and outputs the so expressed gray scale values.

The correlation value estimation unit 314 integrates the correlation values of outputs of the function approximating unit 313.

The offset value calculation unit 315 calculates a position offset of a picture that gives the maximum value of correlation as calculated by the correlation value estimation unit 314. The offset value calculation unit outputs the result of the calculations as an offset value of the corresponding point.

In this corresponding point estimation unit 31, the first partial picture region extraction unit 311 extracts the partial picture region of a frame picture as a template. The second partial picture region extraction unit 312 extracts a partial picture region of another frame picture that is consecutive to the first stated frame picture. The partial picture region extracted is to be similar in shape to the partial picture region extracted by the first partial picture region extraction unit 311. The approximate-by-function unit 313 selects the partial picture regions, extracted by the first and second partial picture region extraction units 311, 312 so that the two partial picture regions will be in the same picture state and expresses the gray scale value of each converted picture in the form of a function by a piece-wise polynomial.

It is now assumed that a picture f₁(x, y) and a picture f₂ (x, y) belong to a space S₍ₘ₎(R₂), and that øm(t) is expressed by a (m−2) degree piece-wise polynomial of the following equation (5):

$$\begin{matrix}[ equation 43 ] & \\ {\hat{φ}}_{m} ( ω ) := {\int }_{t ∈ R}^{ } {e}^{- i ω t} {φ}_{m} ( t ) d t = {( \frac{1 - {e}^{- i ω}}{i ω} )}^{m} & ( 5 )\end{matrix}$$

whilst the space S₍ₘ₎(R₂) is expressed as shown by the following equation (6):

[equation 44]

S^{(m)}(R²)=span{φₘ(·−k)φₘ(·−l)}_{k,lΣZ} (6)

the frame-to-frame correlation function c(τ₁, τ₂) may be expressed by the following equation (7):

[equation 45]

c(τ₁,τ₂)=∫∫f₁(x,y)f₂(x+τ₁,y+τ₂)dxdy (7)

From the above supposition, viz.,

f₁(x,y), f₂(x,y)εS^{(m)}(R²) [equation 46]

the equation (7), expressing the frame-to-frame correlation function, may be shown by the following equation (8):

c(τ₁,τ₂)εS^{(2m)}(R²) (8)

Viz., the frame-to-frame correlation function c(τ₁, τ₂) belongs to the space S₍₂ₘ₎(R₂) in which to perform 2m-degree interpolation shown in FIG. 7, while the sampling frequency ψ₂ₘ(τ₁, τ₂) of the space S₍₂ₘ₎(R₂) in which to perform 2m-degree interpolation uniquely exists, and the above mentioned frame-to-frame correlation function c(τ₁, τ₂) may be expressed by the following equation (9):

[Equation 48]

c(τ₁,τ₂)=ΣₖΣₗc(k,l)ψ₂ₘ(τ₁−l,τ₂−k) (9)

From the equation (8), it is possible to construct the (2m−1) degree piece-wise polynomial for correlation plane interpolation.

Viz., by a block-based motion vector evaluation approach, initial estimation of the motion vectors of separate blocks of the equation (7) may properly be obtained. From this initial estimation, the equation (8) that will give a real motion of optional precision is applied.

The general form of a separable correlation plane interpolation function is represented by the following equation (10):

$$\begin{matrix}[ Equation 49 ] & \\ {ψ}_{2 m} ( x , y ) = {\sum }_{k = - ∞}^{∞} {\sum }_{l = - ∞}^{∞} {c}_{k} {d}_{l} {M}_{2 m} ( x - k ) \times {M}_{2 m} ( y - l ) & ( 10 )\end{matrix}$$

where Ck and dl are correlation coefficients and M₂ₘ(x)=ø₂ₘ(x+2)·øₘ(x) is (m−1) degree B-spline.

By proper truncation limitation in the equation (10), the above mentioned correlation function c(τ₁, τ₂) may be approximated by the following equation (11):

$$\begin{matrix}[ Equation 50 ] & \\ \hat{c} ( {τ}_{1} , {τ}_{2} ) = {\sum }_{k = {K}_{1}}^{{K}_{2}} {\sum }_{l = {L}_{1}}^{{L}_{2}} c ( k , l ) {ψ}_{2 m} ( {τ}_{2} - k ) \times {ψ}_{2 m} ( {τ}_{2} - l ) & ( 11 )\end{matrix}$$

where K₁=[τ₁]−s+1, K₂=[τ₂]+s, L₁=[τ₂]−s+1 and L₂=[τ₂]+s, and s determines øₘ(x).

A desired interpolation equation is obtained by substituting the following equation (12):

$$\begin{matrix}[ Equation 51 ] & \\ {ψ}_{4} ( x , y ) = {\sum }_{k = - ∞}^{∞} {\sum }_{l = - ∞}^{∞} \sqrt{3} {( \sqrt{3} - 2 )}^{\vert k \vert + \vert l \vert} {M}_{4} ( x - k ) \times {M}_{4} ( y - l ) & ( 12 )\end{matrix}$$

into the equation (11) in case m=2, for example.

The motion vector may be derived by using the following equation (13):

$$\begin{matrix}[ Equation 52 ] & \\ \hat{v} = {argmax}_{{τ}_{1} , {τ}_{2}} [ \hat{c} ( {τ}_{1} , {τ}_{2} ) ] & ( 13 )\end{matrix}$$

The above correlation function c(τ₁, τ₂) may be recreated using only the information of integer points. The correlation value estimation unit 314 calculates a correlation value of an output of the function approximating unit 313 by the above correlation function c(τ₁, τ₂).

The offset value calculation unit 315 calculates the motion vector V by the equation (13) that represents the position offset of a picture which will give the maximum value of correlation as calculated by the correlation value estimation unit 314. The offset value calculation unit outputs the resulting motion vector V as an offset value of the corresponding point.

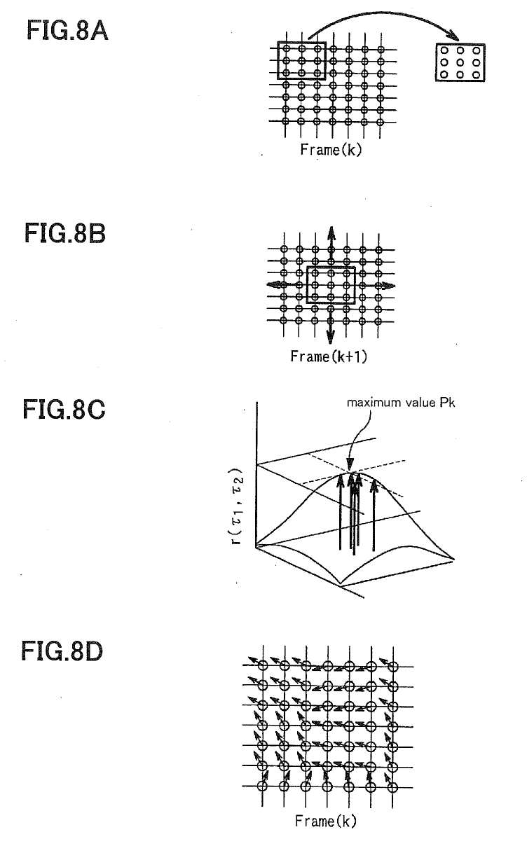

The manner of how the corresponding point estimation unit 31A determines the motion vector by corresponding point estimation is schematically shown in FIGS. 8A to 8D. Viz., the corresponding point estimation unit 31A takes out a partial picture region of a frame picture (k), and extracts a partial picture region of another frame picture different from the frame picture (k), as shown in FIG. 8A. The partial picture region is to be similar in shape to that of the frame picture (k). The corresponding point estimation unit 31A calculates the frame-to-frame correlation, using the correlation coefficient c(τ₁, τ₂) represented by:

c(i,j)=ΣₗΣₘfₖ(l,m)fₖ₊₁(l+i,m+j) [Equation 53]

as shown in FIG. 8B to detect the motion at a peak point of a curved surface of the correlation, as shown in FIG. 8C, to find the motion vector by the above equation (13) to determine the pixel movement in the frame picture (k), as shown in FIG. 8D.

In comparison with the motion vector of each block of the frame picture (k) by conventional block matching, the motion vector of each block of the frame picture (k), determined as described above, shows smooth transition between neighboring blocks.

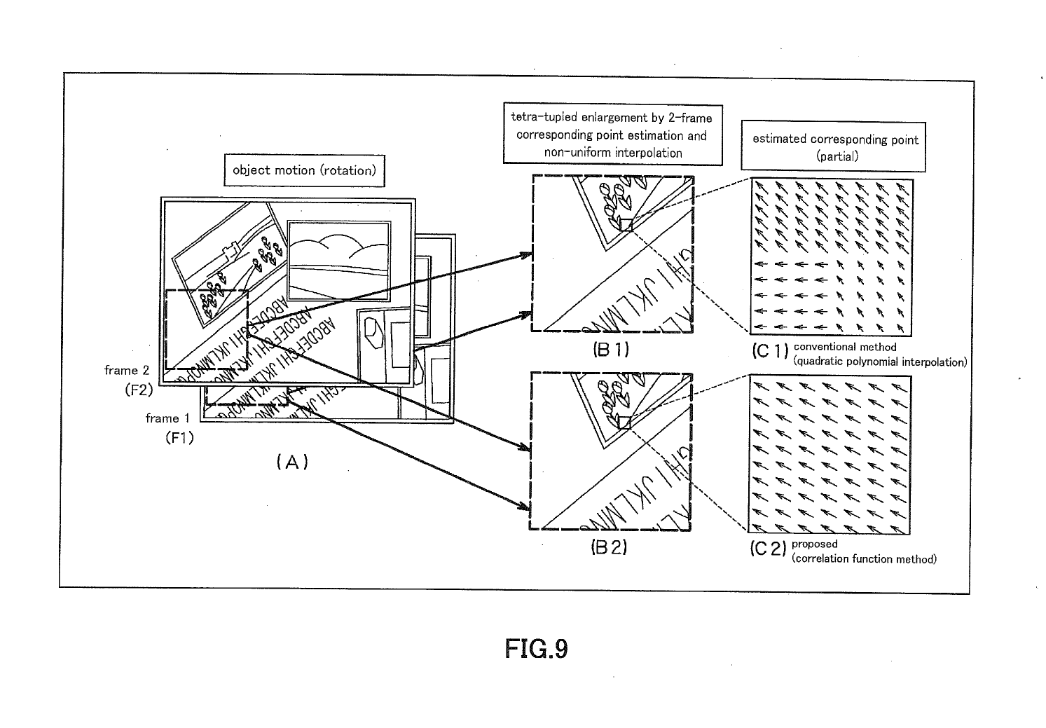

Viz., referring to FIG. 9(A), frames 1 and 2, exhibiting a movement of object rotation, were enlarged by a factor of four by 2-frame corresponding point estimation and non-uniform interpolation. The motion vectors, estimated at the corresponding points by the conventional block matching, showed partially non-uniform variations, as shown in FIGS. 9 (B1), (C1). Conversely, the motion vectors, estimated at the corresponding points by the above described corresponding point estimation unit 31A, exhibit globally smooth variations, as shown in FIGS. 9(B2) and (C2). In addition, the volume of computations at 1/N precision, which is N² with the conventional technique, is N with the present technique,

The render-motion-into-function unit 31B uses the motion vector V, obtained by corresponding point estimation by the corresponding point estimation unit 31A, to render the picture information of the moving portion into the form of a function.

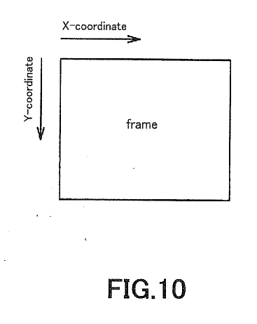

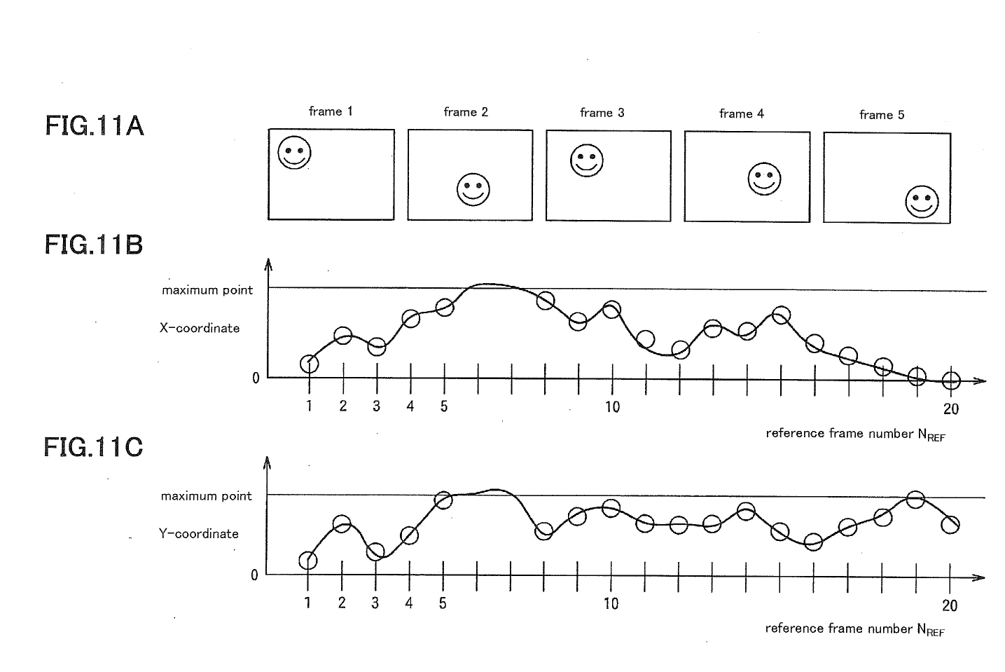

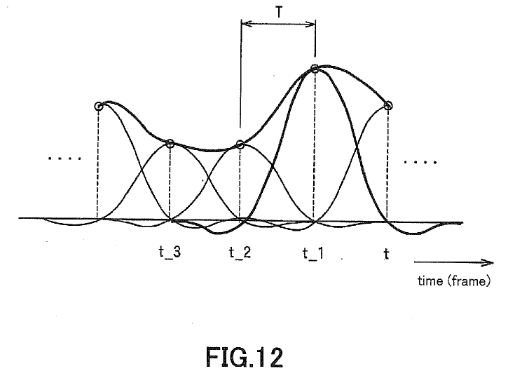

Viz., if once the corresponding point of the partial moving picture is estimated for each reference frame, in the render-motion-into-function unit 31B, the amount of movement, that is, the offset value, of the corresponding point, corresponds to the change in the frame's coordinate positions x, y. Thus, if the point of origin of the frame is set at an upper left corner, as shown in FIG. 10, the render-motion-into-function unit 31B expresses the picture movement of each frame, shown for example in FIG. 11A, as the movements of the frame's X- and Y-coordinates, as shown in FIGS. 11B and 11C. Thus, the render-motion-into-function unit 31B renders changes in the movements of the X- and Y-coordinates by a function by way of approximating the changes in movement into a function. The render-motion-into-function unit 31B estimates the inter-frame position T by interpolation with the function, as shown in FIG. 12, by way of performing the motion compensation.

On the other hand, the second render-into-function processor 32 encodes the input picture by the render-into-fluency-function processing, in which the information on the contour and the gray level as well as on the frame-to-frame information is approximated based on the theory of the fluency information. The second render-into-function processor 32 is composed of an automatic region classification processor 32A, a approximate-contour-line-by-function processor 32B, a render-gray-level-into-function processor 32C and an approximate-by-frequency-function processor 32D.

Based on the theory of the fluency information, the automatic region classification processor 32A classifies the input picture into a piece-wise planar surface region (m≦2), a piece-wise curved surface region (m=3), a piece-wise spherical surface region (m=∞) and an irregular region (region of higher degree, e.g., m≧4).

In the theory of the fluency information, a signal is classified by a concept of ‘signal space’ based on classes specified by the number of degrees m.

The signal space ₘS is expressed by a piece-wise polynominal of the (m−1) degree having a variable that allows for (m−2) times of successive differentiation operations.

It has been proved that the signal space ₘS becomes equal to the space of the step function for m=1, while becoming equal to the space of the SINC function for m=∞. A fluency model is such a model that, by defining the fluency sampling function, clarifies the relationship between the signal belonging to the signal space ₘS and the discrete time-domain signal.

The approximate-contour-line-by-function processor 32B is composed of an automatic contour classification processor 321 and an approximate-by-function processor 322. The approximate-contour-line-by-function processor 32B extracts line segments, arcs and quadratic (degree-2) curves, contained in the piece-wise planar region (m≦2), piece-wise curved surface region (m=3) and the piece-wise spherical surface region (m=∞), classified by the automatic region classification processor 32A, for approximation by a function by the approximate-by-function processor 322.

The render-gray-level-into-function processor 32C performs the processing of render-gray-level-into-function processing on the piece-wise planar region (m≦2), piece-wise curved surface region (m=3) and the piece-wise spherical surface region (m=∞), classified by the automatic region classification processor 32A, with the aid of the fluency function.

The approximate-by-frequency-function processor 32D performs the processing of approximation by the frequency function, by LOT (logical orthogonal transform) or DCT, for irregular regions classified by the automatic region classification processor 32A, viz., for those regions that may not be represented by polynomials.

This second render-gray-level-into-function processor 32 is able to express the gray level or the contour of a picture, using the multi-variable fluency function, from one picture frame to another.

The encoding processor 33 states the picture information, put into the form of the function by the first render-into-function processor 31 and the second render-into-function processor 32, in a predetermined form by way of encoding.

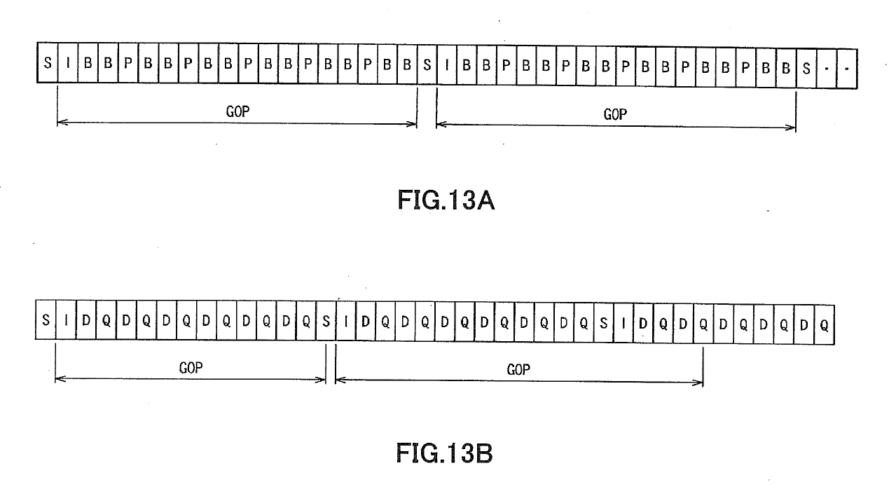

In MPEG encoding, an I-picture, a B-picture and a P-picture are defined. The I-picture is represented by frame picture data that has recorded a picture image in its entirety. The B-picture is represented by differential picture data as predicted from the forward and backward pictures. The P-picture is represented by differential picture data as predicted from directly previous I- and P-pictures. In the MPEG encoding, a picture data stream shown in FIG. 13A is generated by way of an encoding operation. The picture data stream is a string of encoded data of a number of pictures arranged in terms of groups of frames or pictures (GOPs) provided along the tine axis, as units. Also, the picture data stream is a string of encoded data of luminance and chroma signals having DCTed quantized values. The encoding processor 33 of the picture signal conversion system 100 performs the encoding processing that generates a picture data stream configured as shown for example in FIG. 13B.

Viz., the encoding processor 33 defines an I-picture, a D-picture and a Q-picture. The I-picture is represented by frame picture function data that has recorded a picture image in its entirety. The D-picture is represented by frame interpolation differential picture function data of forward and backward I- and Q-pictures or Q- and Q-pictures. The Q-picture is represented by differential frame picture function data from directly previous I- or Q-pictures. The encoding processor 33 generates a picture data stream configured as shown for example in FIG. 13B. The picture data stream is composed of a number of encoded data strings of respective pictures represented by picture function data, in which the encoded data strings are arrayed in terms of groups of pictures (GOPs) composed of a plurality of frames grouped together along the time axis.

It should be noted that a sequence header S is appended to the picture data stream shown in FIGS. 13A and 13B.

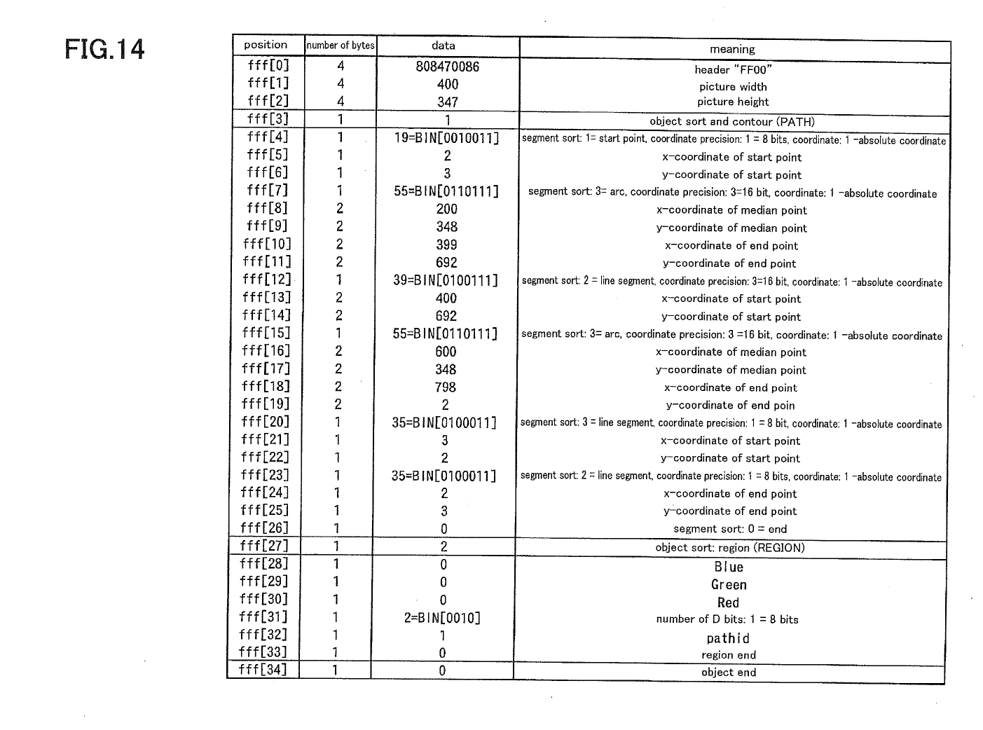

An example bit format of the I- and Q-pictures in the picture data stream generated by the encoding processor 33 is shown in FIG. 14. Viz., the picture function data indicating the I- and Q-pictures includes the header information, picture width information, picture height information, the information indicating that the object sort is the contour, the information indicating the segment sort in the contour object, the coordinate information for the beginning point, median point and the terminal point, the information indicating that the object sort is the region, and the color information of the region object.

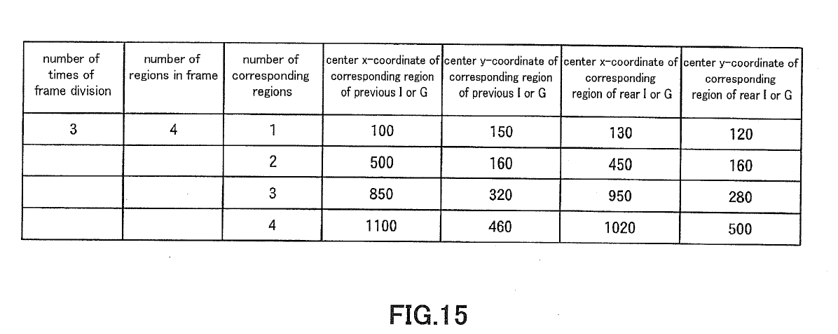

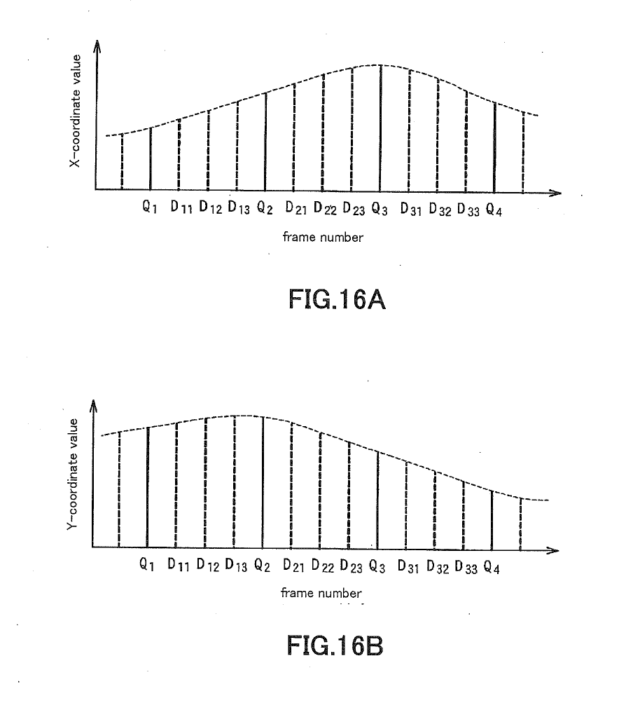

FIG. 15 shows an example bit format of a D-picture in a picture data stream generated by the encoding processor 33. The picture function data, representing the D-picture, there is contained the information on, for example, the number of frame division, the number of regions in a frame, the corresponding region numbers, center X- and Y-coordinates of corresponding regions of a previous I-picture or a previous P-picture, and on the center X- and Y-coordinates of corresponding regions of the backward I-picture or the backward P-picture. FIGS. 16A and 16B show transitions of the X- and Y-coordinates of the corresponding points of the region number 1 in the example bit format of the D-picture shown in FIG. 15.

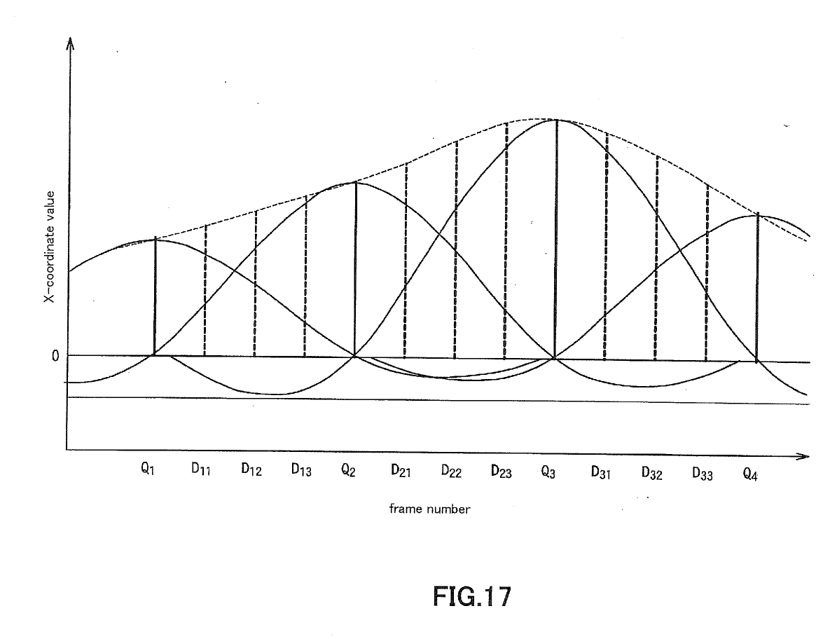

Referring to FIG. 17, the X-coordinate values of the D-pictures in the corresponding region (D21, D22 and D23) may be calculated by interpolation calculations from the X-coordinate values of previous and succeeding pictures (Q1, Q2, Q3 and Q4). The Y-coordinate values of the D-pictures in the corresponding region (D21, D22 and D23) may be calculated by interpolation calculations from the Y-coordinate values of previous and succeeding pictures (Q1, Q2, Q3 and Q4)

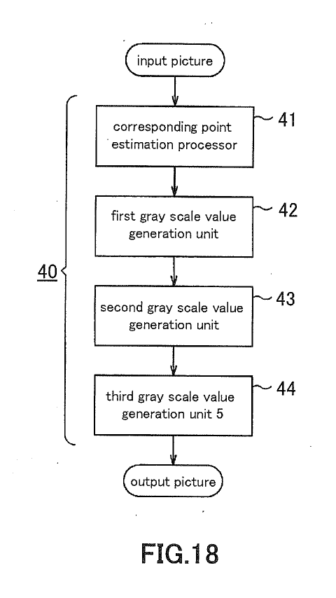

A frame rate conversion system 40 according to the embodiment of the present invention is constructed as shown for example in FIG. 18.

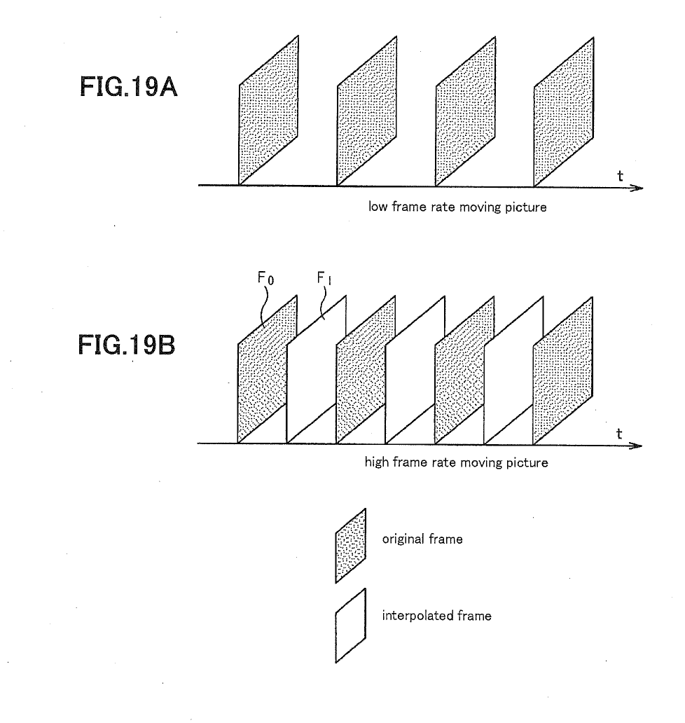

The present frame rate conversion system 40 introduces a frame for interpolations F₁ in-between original frames F₀, as shown for example in FIGS. 19A and 19B. The frame rate may be enhanced by converting a moving picture of a low frame rate, 30 frames per second in the present example, as shown in FIG. 19A, into a moving picture of a high frame rate, 60 frames per second in the present example, as shown in FIG. 19B. The frame rate enhancing unit 40 is in the form of a computer including a corresponding point estimation unit 41, a first gray scale value generation unit 42, a second gray scale value generation unit 43 and a third gray scale value generation unit 44.

In the present frame rate enhancing unit 40, the corresponding point estimation unit 41 estimates, for each of a large number of pixels in a reference frame, a corresponding point in each of a plurality of picture frames temporally different from the reference frame and from one another.

The first gray scale value generation unit 42 finds, for each of the corresponding points in the respective picture frames, as estimated by the corresponding point estimation unit 41, the gray scale value from gray scale values indicating the gray levels of neighboring pixels.

The second gray scale value generation unit 43 approximates, for each of the pixels in the reference frame, the gray levels on the locus of the corresponding points, based on the gray scale values of the corresponding points as estimated in the respective picture frames, by a fluency function. From this function, the second gray scale value generation unit finds the gray scale value of each corresponding point in each frame for interpolation.

The third gray scale value generation unit 44 then generates, from the gray scale value of each corresponding point in each frame for interpolation, the gray scale values of pixels in the neighborhood of each corresponding point in each frame for interpolation.

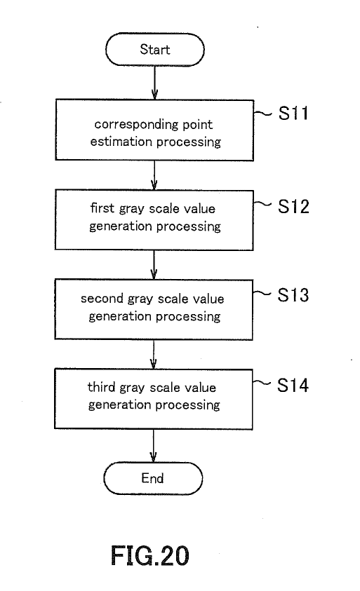

The present frame rate enhancing unit 40 in the present frame rate conversion system 100 executes, by a computer, a picture signal conversion program as read out from a memory, not shown. The frame rate conversion device performs the processing in accordance with the sequence of steps S11 to S14 shown in the flowchart of FIG. 20. Viz., using the gray scale value of each corresponding point, as estimated by corresponding point estimation, the gray scale value of each corresponding point of each frame for interpolation is generated by uniform interpolation. In addition, the gray scale values of the pixels at the pixel points in the neighborhood of each corresponding point in each frame for interpolation are generated by non-uniform interpolation, by way of processing for enhancing the frame rate.

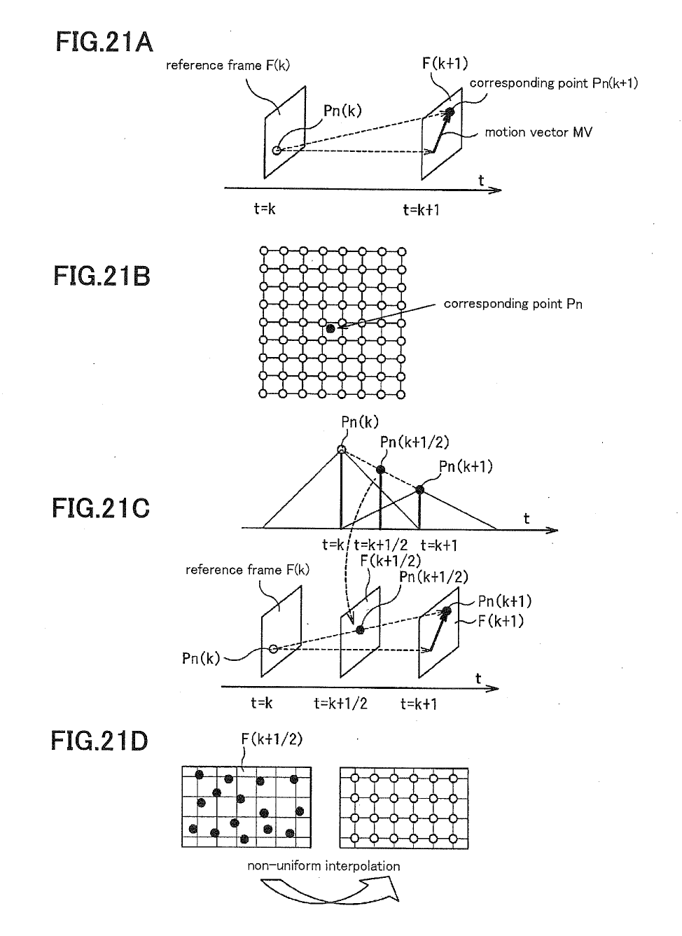

In more detail, in the, a picture frame at time t=k is set as a reference frame F(k), as shown in FIG. 21A. Then, for each of a large number of pixels Pn(k) in the reference frame F(k), motion vectors are found for each of a picture frame F(k+1) at time t=k+1, a picture frame F(k+2) at time t=k+2, . . . , a picture frame F(k+m) at time t=k+m to estimate corresponding points Pn(k+1), Pn(k+2), . . . , Pn(k+m) in the picture frames F(k+1), F(k+2), . . . , F(k+m), by way of performing the processing of estimating the corresponding points (step S11).

Then, for each of the corresponding points Pn(k+1), Pn(k+2), . . . , Pn(k+m) in the picture frames F(k+1), F(k+2), . . . , F(k+m), estimated in the above step S11, the gray scale value is found from the gray scale values representing the gray levels of the neighboring pixels, by way of performing the first processing for generation of the gray scale values, as shown in FIG. 21B (step S12).

Then, for each of a large number of pixels Pn(k) in the reference frame F(k), the second processing for generation of the gray scale values is carried out, as shown in FIG. 21C (step S3). In this second processing for generation of the gray scale values, the gray levels at the corresponding points Pn(k+1), Pn(k+2), . . . , Pn(k+m), generated in the step S2, viz., the gray levels on the loci of the corresponding points in the picture frames F(k+1), F(k+2), . . . , F(k+m), are approximated by the fluency function. From this fluency function, the gray scale values of the corresponding points in the frames for interpolations intermediate between the picture frames F(k+1), F(k+2), . . . , F(k+m) are found (step S13).

In the next step S14, the third processing for generation of the gray scale values is carried out, as shown in FIG. 21D. In this processing, from the gray scale values of the corresponding points of a frame for interpolation F(k+1)/2, generated by the second processing of generating the gray scale value of step S13, the gray scale values of pixels in the frame for interpolation F(k+½) at time t=k+½ are found by non-uniform interpolation (step S14).

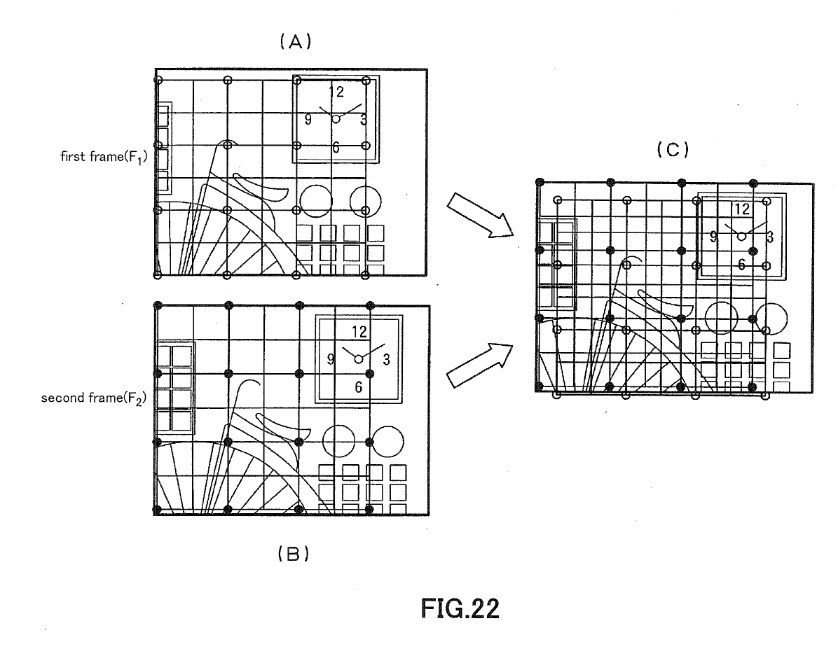

In a moving picture composed of a plurality of frames, the position in a frame of a partial picture performing the motion differs from one frame to another. Moreover, a pixel point on a given frame is not necessarily moved to a pixel point at a different position on another frame, but rather more probably the pixel point is located between pixels. Viz., if a native picture is arranged as the time-continuous information, the pixel information represented by such native picture would be at two different positions on two frames. In particular, if the new frame information is generated by interpolation between different frames, the picture information on the original frames would differ almost unexceptionally from the pixel information on the newly generated frame. Suppose that two frames shown at (A) and (B) in FIG. 22 are superposed at certain corresponding points of each frame. In this case, the relationship among the pixel points of the respective frames, shown only roughly for illustration, is as shown in at (C) in FIG. 22. That is, the two frames become offset a distance corresponding to the picture movement. If the gray scale values of lattice points of the first frame (non-marked pixel points) are to be found using these two frame pictures, the processing of non-uniform interpolation is necessary.

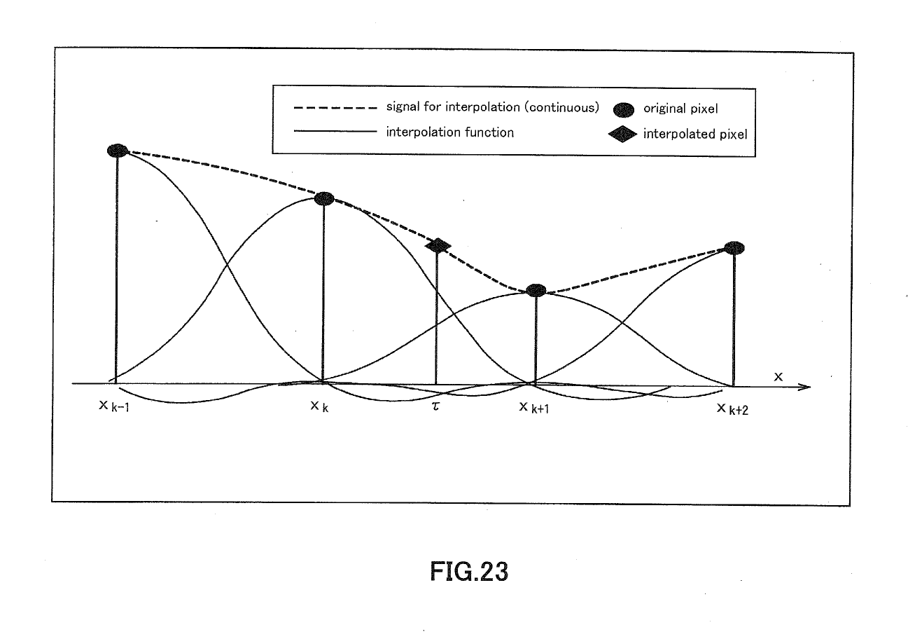

For example, the processing for picture interpolation of determining the value of the position of a pixel u(τₓ, τ_{y}), newly generated on converting the picture resolution, is carried out by convolution of an original pixel u(x₁, y₁) with an interpolation function h(x), as shown in FIG. 23:

$$u ( {τ}_{x} , {τ}_{y} ) = {\sum }_{i = - ∞}^{∞} {\sum }_{j = - ∞}^{∞} u ( {x}_{i} - {y}_{j} ) h ( {τ}_{x} - {x}_{i} , {τ}_{y} - {y}_{j} ) \qquad [ Equation 54 ]$$

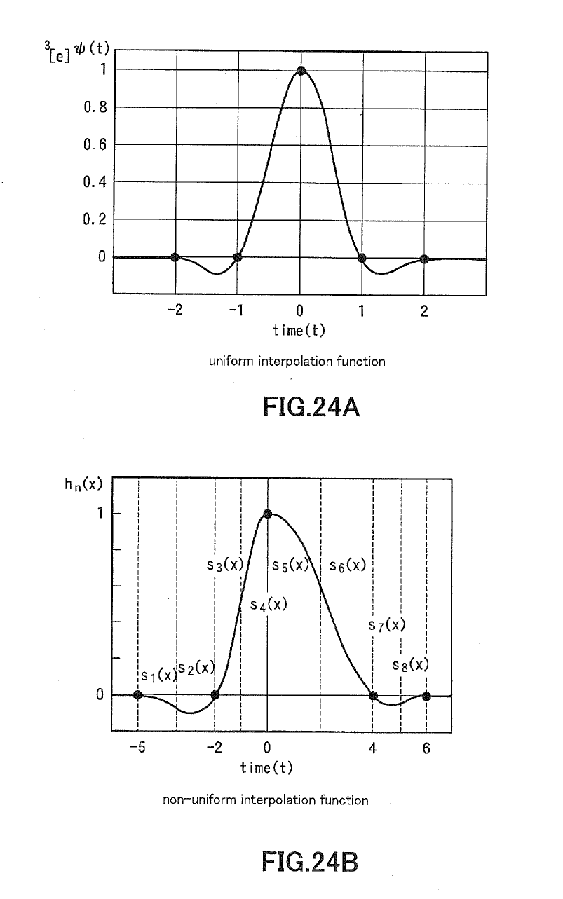

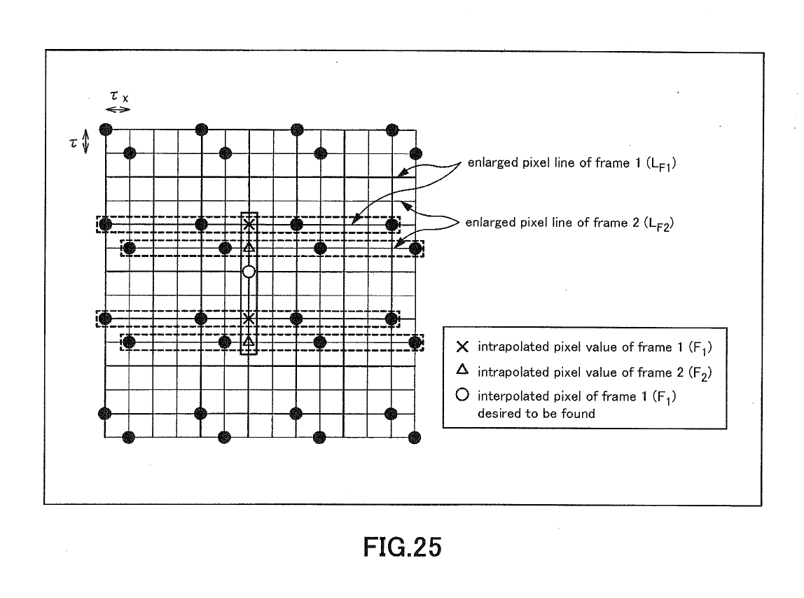

The same partial picture regions of a plurality of frame pictures are then made to correspond to one another. The interpolation information, as found from frame to frame by uniform interpolation from the pixel information of the horizontal (vertical) direction in the neighborhood of a desired corresponding point, using the uniform interpolation function shown in FIG. 24(A), viz., the intrapolated pixel values x, Δ of the frames 1 (F1) and 2 (F2) (see FIG. 25), as the pixel information in the vertical (horizontal) direction, are processed with non-uniform interpolation, based on the value of frame offset, using the non-uniform interpolation function shown in FIG. 24(B). By so doing, the pixel information at a desired position o in the frame 1 is determined.

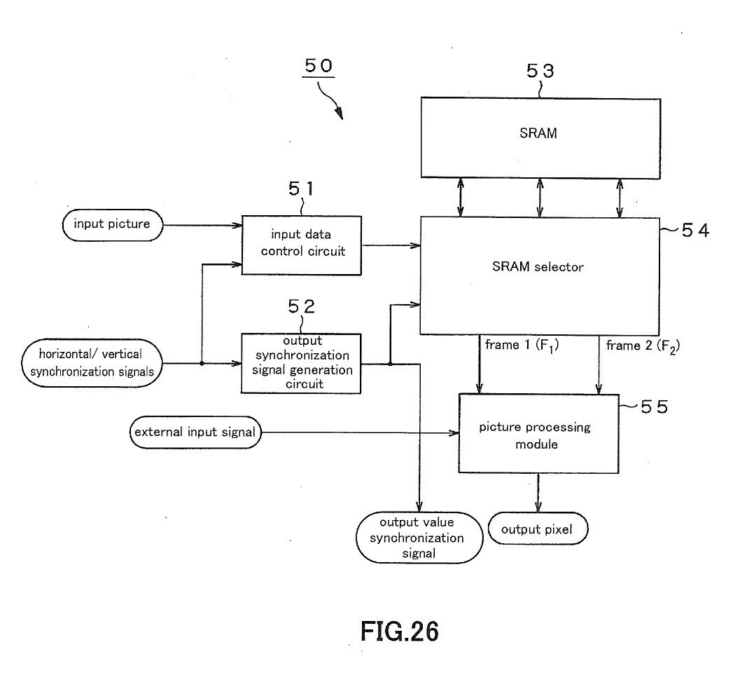

It should be noted that the frame rate enhancing processor 40 not only has the above described function of enhancing the frame rate, but also may have the function of performing the processing of enlarging interpolation with the use of two frame pictures. The function of the enlarging interpolation using two frame pictures may be implemented by an enlarging interpolation processor 50 including an input data control circuit 51, an output synchronization signal generation circuit 52, an SRAM 53, an SRAM selector 54 and a picture processing module 55, as shown for example in FIG. 26.

In this enlarging interpolation processor 50, the input data control circuit 51 manages control of sequentially supplying an input picture, that is, the picture information of each pixel, supplied along with the horizontal and vertical synchronization signals, to the SRAM selector 54.

The output synchronization signal generation circuit 52 generates an output side synchronization signal, based on the horizontal and vertical synchronization signals supplied thereto, and outputs the so generated output side synchronization signal, while supplying the same signal to the SRAM selector 54.

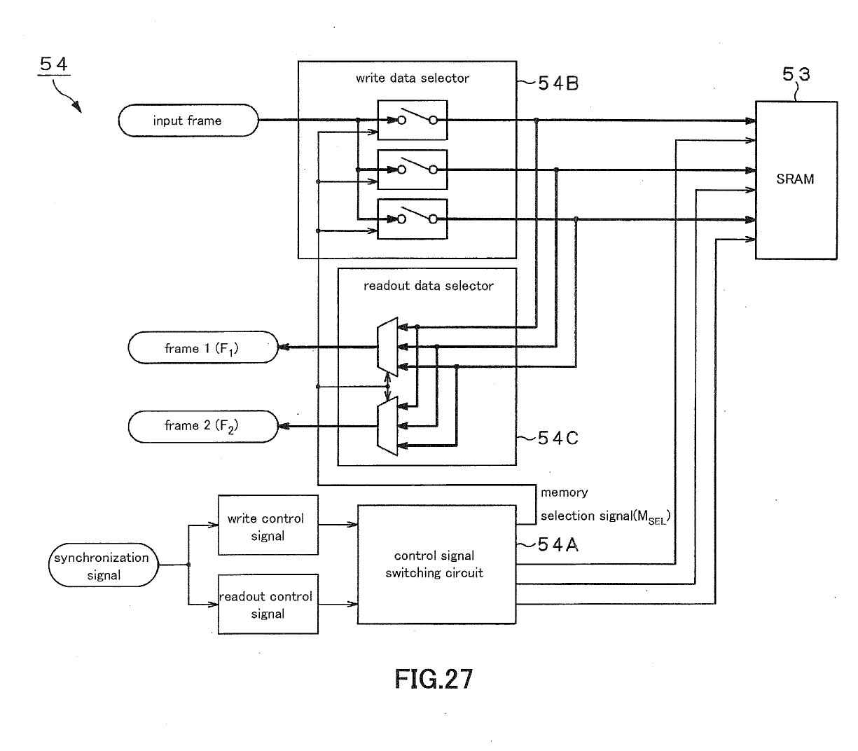

The SRAM selector 54 is constructed as shown for example in FIG. 27, and includes a control signal switching circuit 54A, a write data selector 54B, a readout data selector 54C and an SRAM 53. The write data selector 54B performs an operation in accordance with a memory selection signal delivered from the control signal switching circuit 54A based on a write control signal and a readout control signal generated with the synchronization signals supplied. An input picture from the input data control circuit 51 is entered, on the frame-by-frame basis, to the SRAM 53, at the same time as two-frame pictures are read out in synchronization with the output side synchronization signal generated by the output synchronization signal generation circuit 52.

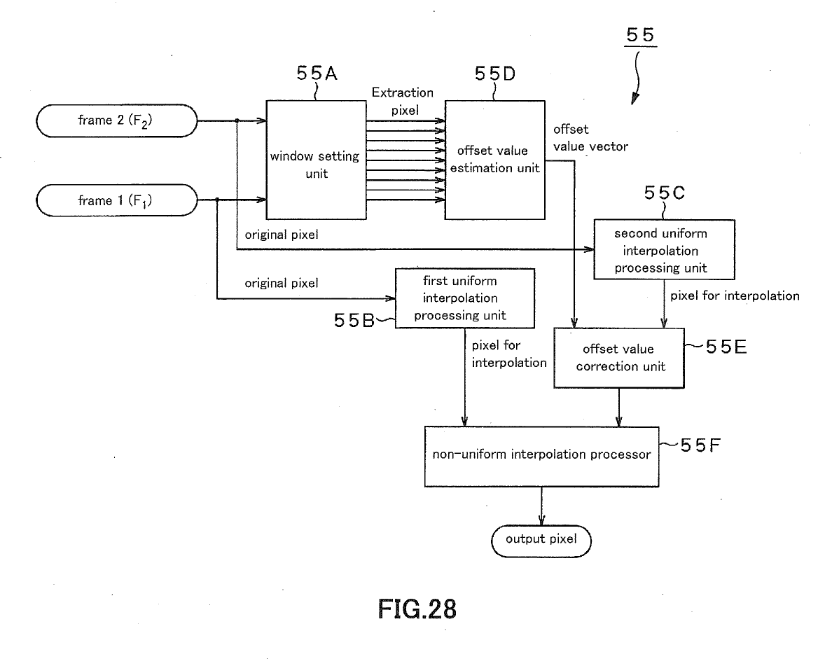

The picture processing module 55, performing the processing for picture interpolation, based on the frame-to-frame information, is constructed as shown in FIG. 28.

Viz., the picture processing module 55 includes a window setting unit 55A supplied with two frames of the picture information read out simultaneously from the SRAM 53 via SRAM selector 54. The picture processing module also includes a first uniform interpolation processing unit 55B and a second uniform interpolation processing unit 55C. The picture processing module also includes an offset value estimation unit 55D supplied with the pixel information extracted from the above mentioned two-frame picture information by the window setting unit 55A. The picture processing module also includes an offset value correction unit 55E supplied with an offset value vector estimated by the offset value estimation unit 55D and with the pixel information interpolated by the second uniform interpolation processing unit 55C. The picture processing module further includes a non-uniform interpolation processor 55F supplied with the pixel information corrected by the offset value correction unit 55E and with the pixel information interpolated by the first uniform interpolation processing unit 55B.

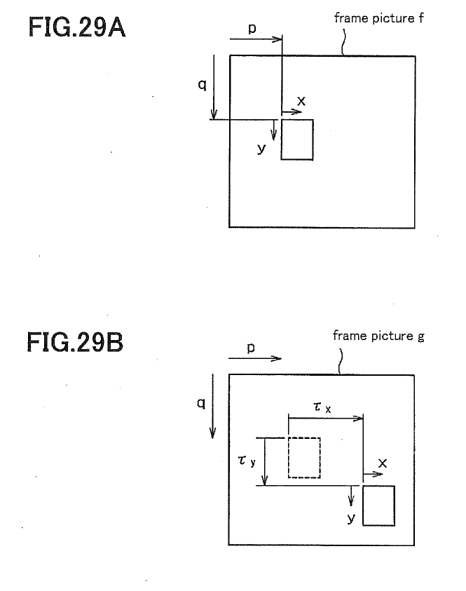

In the picture processing module 55, the window setting unit 55A sets a window at preset points (p, q) for two frame pictures f, g entered via the SRAM selector 54, as shown in FIGS. 29A and 29B. The offset value estimation unit 55D shifts the window of the frame picture g by an offset value (τx, τy). The picture processing module then performs scalar product operation for the pixel values of the relative position (x, y) in the window. The resulting value is to be a cross-correlation value Rpq (τx, τy).

Rpq(τₓ,τ_{y})=ΣₓΣ_{y}[f(p+x,q+y)g(p+x+τₓ,q+y+τ_{y})] [Equation 55]

The offset values (τx, τy) are varied to extract the offset value (τx, τy) which will maximize the cross-correlation value Rpq (τx, τy) around the point (p, q).

offset value (τx,τy)={Rpq(τx,τy)}ₘₐₓ [Equation 56]

Meanwhile, it is also possible to Fourier transform in-window pixel data of the two frame pictures f, g in order to find the cross-correlation Rpq (τx, τy).

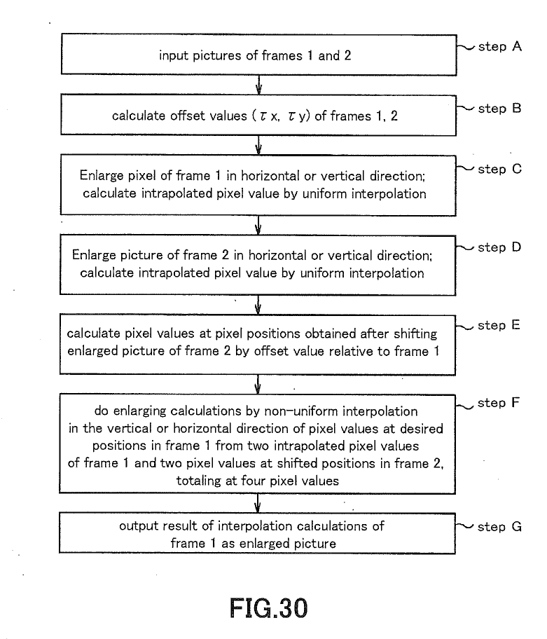

The present enlarging interpolation processor 50 executes the processing of enlarging interpolation in accordance with a sequence shown by the flowchart of FIG. 30.

That is, if, in the picture processing module 55, the two frame pictures f, g are read out via the SRAM selector 54 from the SRAM 53 (step A), the offset value estimation unit 55D calculates, by processing of correlation, an offset value (τx, τy) of the two frame pictures f, g (step B).

Pixel values of the picture f of the frame 1, intrapolated by uniform interpolation, are calculated by uniform interpolation by the first uniform interpolation processing unit 55B for enlarging the picture in the horizontal or vertical direction (step C).

Pixel values of the picture g of the frame 2, intrapolated by uniform interpolation, are calculated by the second uniform interpolation processing unit 55C for enlarging the picture in the horizontal or vertical direction (step D).

Then, pixel values at pixel positions of the enlarged picture of the frame 2, shifted by the picture offset value relative to the frame 1, are calculated by the offset value correction unit 55E (step E).

The non-uniform interpolation processor 55F then executes enlarging calculations, from two intrapolated pixel values of the frame 1 and two pixel values of the frame 2 at the shifted position, totaling at four pixel values, on the pixel values of the positions of the frame 1, desired to be found, in the vertical or horizontal direction, by non-uniform interpolation (step F). The results of the interpolation calculations for the frame 1 are then output as an enlarged picture (step G).

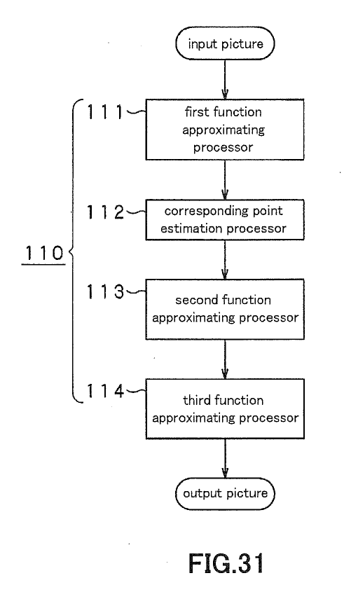

A frame rate conversion device 110, having the function of performing the processing of such enlarging interpolation, is constructed as shown for example in FIG. 31.

The frame rate conversion device 110 is comprised of a computer made up of a first function approximating processor 111, a corresponding point estimation processor 112, a second function approximating processor 113 and a third function approximating processor 114.

The first function approximating processor 111 executes first function approximation processing of approximating the gray level distribution of the multiple pixels of the reference frame by a function.

The corresponding point estimation processor 112 performs correlation calculations, using the function of the gray level distribution in a plurality of reference frames at varying time points, as approximated by the first function approximating processor 111. The corresponding point estimation processor then sets respective positions that will yield the maximum value of correlation as the position of corresponding points in the multiple reference frames, by way of processing of corresponding point estimation.

The second function approximating processor 113 renders the corresponding point positions in each reference frame, estimated by the corresponding point estimation processor 112, into coordinate values corresponding to vertical and horizontal distances from the point of origin of the reference frame. Variations in the vertical and horizontal positions of the coordinate values in the multiple reference frames at varying time points are converted into time series signals, which time series signals are then approximated by a function, by way of the second approximation by a function,

The third function approximating processor 114 uses the function approximated by the second function approximating processor 113, for a frame for interposition at an optional time point between multiple reference frames, to find the gray scale value at corresponding points of the frame for interpolation by interpolation with the gray scale values at the corresponding points in the reference frame. The corresponding points are the corresponding points of the frame for interpolation relevant to the corresponding points on the reference frame. The above mentioned first function approximation is made to fit with the gray scale value of the corresponding point of the frame for interpolation to find the gray scale distribution in the neighborhood of the corresponding point. The gray scale value in the neighborhood of the corresponding point is converted into the gray scale value of the pixel point in the frame for interpolation by way of performing the third function approximation.

In the present frame rate conversion device 110, the first function approximating processor 111 performs function approximation of the gray scale distribution of a plurality of pixels in the reference frame. The corresponding point estimation processor 112 performs correlation calculations, using the function of the gray scale distribution in the multiple reference frames at varying time points as approximated by the first function approximating processor 111. The positions that yield the maximum value of correlation are set as point positions corresponding to pixels in the multiple reference frames. The second function approximating processor 113 renders the corresponding point positions in each reference frame, estimated by the corresponding point estimation processor 112, into coordinate points in terms of vertical and horizontal distances from the point of origin of the reference frame. Variations in the vertical and horizontal positions of the coordinate points in the multiple reference frames, taken at varying time points, are converted into a time series signal, which time series signal is then approximated by a function. The third function approximating processor 114 uses the function approximated by the second function approximating processor 113 to find the gray scale values at corresponding point positions of the frame for interpolation by interpolation with the gray scale values at the corresponding points of the reference frame. The corresponding point position of the frame for interpolation is relevant to a corresponding point position in the reference frame. The above mentioned first function approximation is made to fit with the gray scale value of the corresponding point of the frame for interpolation to find the gray scale distribution in the neighborhood of the corresponding point. The gray scale value in the neighborhood of the corresponding point of the reference frame is converted into the gray scale value of the pixel point in the frame for interpolation by way of performing third function approximation.

In the picture signal conversion system 100, the pre-processor 20 removes the noise from the picture information, supplied from the picture input unit 10, such as a picture pickup device. The compression encoding processor 30 encodes the picture information, freed of the noise by the pre-processor 20, by way of signal compression. The frame rate enhancing unit 40, making use of the frame rate conversion device 1, traces the frame-to-frame corresponding points, and expresses the time transitions by a function to generate a frame for interpolation, expressed by a function, based on a number ratio of the original frame(s) and the frames to be generated on conversion.

Viz., the present picture signal conversion system 100 expresses e.g., the contour, using a larger number of fluency functions, from one picture frame to another, while expressing the string of discrete frames along the time axis by a time-continuous function which is based on the piece-wise polynomial in the time domain. By so doing, the high-quality pictures may be reproduced at an optional frame rate.

In the theory of the fluency information, the signal space of a class specified by the number of degrees m is classified based on the relationship that a signal may be differentiated continuously.

For any number m such that m>0, the subspace spanned is represented by a (m−1) degree piece-wise polynomial that may be continuously differentiated just (m−2) number of times.

The sampling function ψ(x) of the class (m=3) may be expressed by linear combination of the degree-2 piece-wise polynomial that may be continuously differentiated only once, by the following equation (14):

$$\begin{matrix}[ Equation 57 ] & \\ ψ ( x ) = - \frac{τ}{2} φ ( x + \frac{τ}{2} ) + 2 τφ ( x ) - \frac{τ}{2} φ ( x - \frac{τ}{2} ) & ( 14 )\end{matrix}$$

where ø(x) may be represented by the following equation (15):

$$\begin{matrix}[ Equation 58 ] & \\ φ ( x ) = {\int }_{- ∞}^{∞} {( \frac{sin π f τ}{π f τ} )}^{3} {e}^{j2π fx} d f & ( 15 )\end{matrix}$$

Since ψ(x) is a sampling function, the function of a division may be found by convolution with the sample string.

If τ=1, the equation (13) may be expressed by a piece-wise polynomial given by the following equation (16):

$$\begin{matrix}[ Equation 59 ] & \\ {h}_{f} ( x ) = \{ \begin{matrix}- \frac{7}{4} {x}^{2} + 1 & \vert x \vert ∈ [ - \frac{1}{2} , \frac{1}{2} ] \\ \frac{5}{4} {x}^{2} - 3 \vert x \vert + \frac{7}{4} & \vert x \vert ∈ [ \frac{1}{2} , 1 ] \\ \frac{3}{4} {x}^{2} - 2 \vert x \vert + \frac{5}{4} & \vert x \vert ∈ [ 1 , \frac{3}{2} ] \\ - \frac{1}{4} {x}^{2} + \vert x \vert - 1 & \vert x \vert ∈ [ \frac{3}{2} , 2 ] \\ 0 & otherwise\end{matrix} & ( 16 )\end{matrix}$$

For example, the non-uniform fluency function of the class (m=3):

h_{f}(x) [Equation 60]

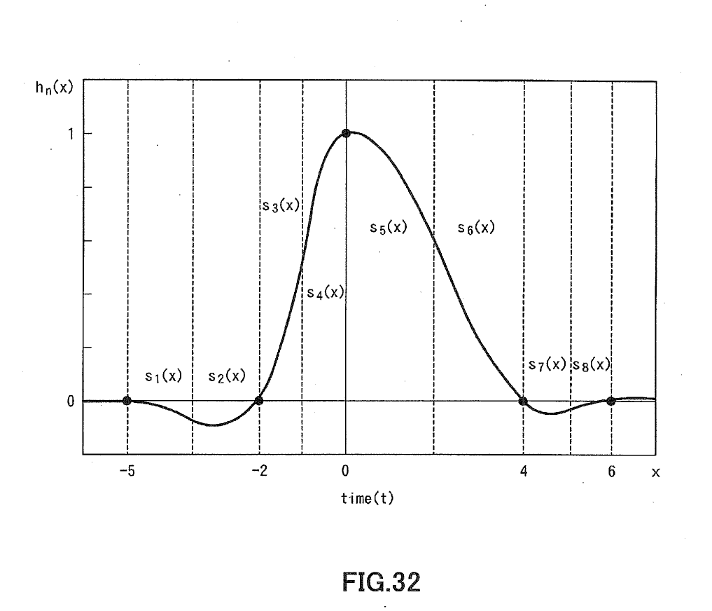

is a function shown in FIG. 32.

A non-uniform interpolation fluency function

hₙ(x) [Equation 61]

is composed of eight piece-wise polynomials of the degree 2. A non-uniform interpolation fluency function of the (m=3) class is determined by the non-uniform interval specified by sₜ(x)˜s₈(x), as shown in FIG. 32, and its constituent elements may be given by the following equation (17):

$$\begin{matrix}[ Equation 62 ] & \\ \{ \begin{matrix}{s}_{1} ( t ) = - {{B}_{1} ( t - {t}_{- 2} )}^{2} \\ {s}_{2} ( t ) = {B}_{1} ( 3 t - {t}_{- 1} - 2 {t}_{- 2} ) ( t - {t}_{- 1} ) \\ {s}_{3} ( t ) = - {B}_{2} ( 3 t - 2 {t}_{0} - {t}_{- 1} ) ( t - {t}_{- 1} ) + \frac{2 {( t - {t}_{- 1} )}^{2}}{{( {t}_{0} - {t}_{- 1} )}^{2}} \\ {s}_{4} ( t ) = {{B}_{2} ( t - {t}_{0} )}^{2} - \frac{2 {( t - {t}_{0} )}^{2}}{{( {t}_{0} - {t}_{- 1} )}^{2}} \\ {s}_{5} ( t ) = {{B}_{3} ( t - {t}_{0} )}^{2} - \frac{2 {( t - {t}_{0} )}^{2}}{{( {t}_{0} - {t}_{1} )}^{2}} \\ {s}_{6} ( t ) = - {B}_{3} ( 3 t - 2 {t}_{0} - {t}_{1} ) ( t - {t}_{1} ) + \frac{2 {( t - {t}_{1} )}^{2}}{{( {t}_{0} - {t}_{1} )}^{2}} \\ {s}_{7} ( t ) = {B}_{4} ( 3 t - {t}_{1} - 2 {t}_{2} ) ( t - {t}_{1} ) \\ {s}_{8} ( t ) = - {{B}_{4} ( t - {t}_{2} )}^{2}\end{matrix} & ( 17 ) \\ where & \\ \{ \begin{matrix}{B}_{1} = \frac{{t}_{0} - {t}_{- 2}}{4 {( {t}_{0} - {t}_{- 1} )}^{2} ( {t}_{- 1} - {t}_{- 2} ) + 4 {( {t}_{- 1} - {t}_{- 2} )}^{3}} \\ {B}_{2} = \frac{{t}_{0} - {t}_{- 2}}{4 ( {t}_{0} - {t}_{- 1} ) {( {t}_{- 1} - {t}_{- 2} )}^{2} + 4 {( {t}_{0} - {t}_{- 1} )}^{3}} \\ {B}_{3} = \frac{{t}_{2} - {t}_{0}}{4 {( {t}_{2} - {t}_{1} )}^{2} ( {t}_{1} - {t}_{0} ) + 4 {( {t}_{1} - {t}_{0} )}^{3}} \\ {B}_{4} = \frac{{t}_{2} - {t}_{0}}{4 ( {t}_{2} - {t}_{1} ) ( {t}_{1} - {t}_{0} ) + 4 {( {t}_{2} - {t}_{1} )}^{3}}\end{matrix} & [ Equation 63 ]\end{matrix}$$

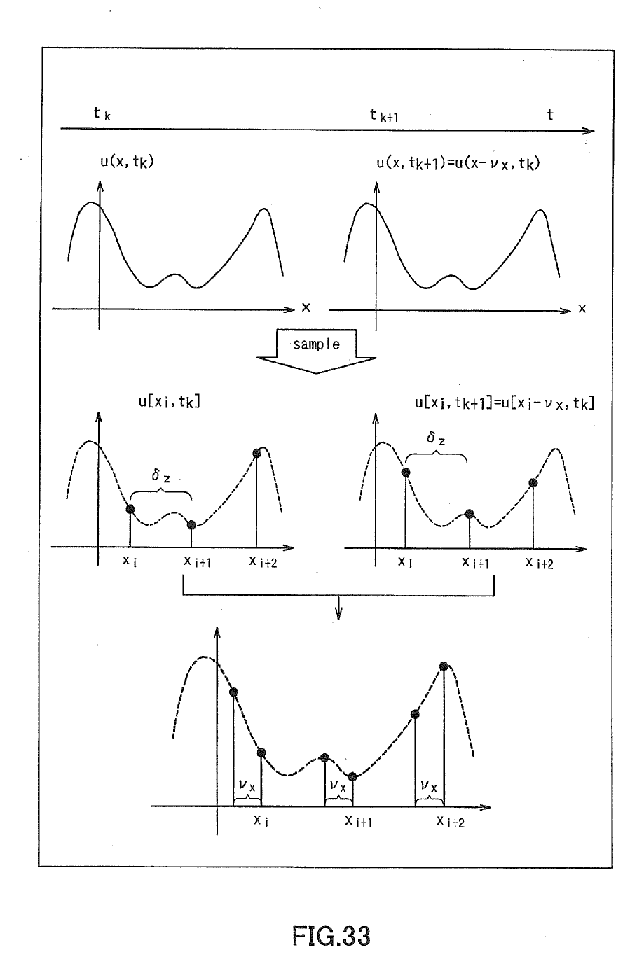

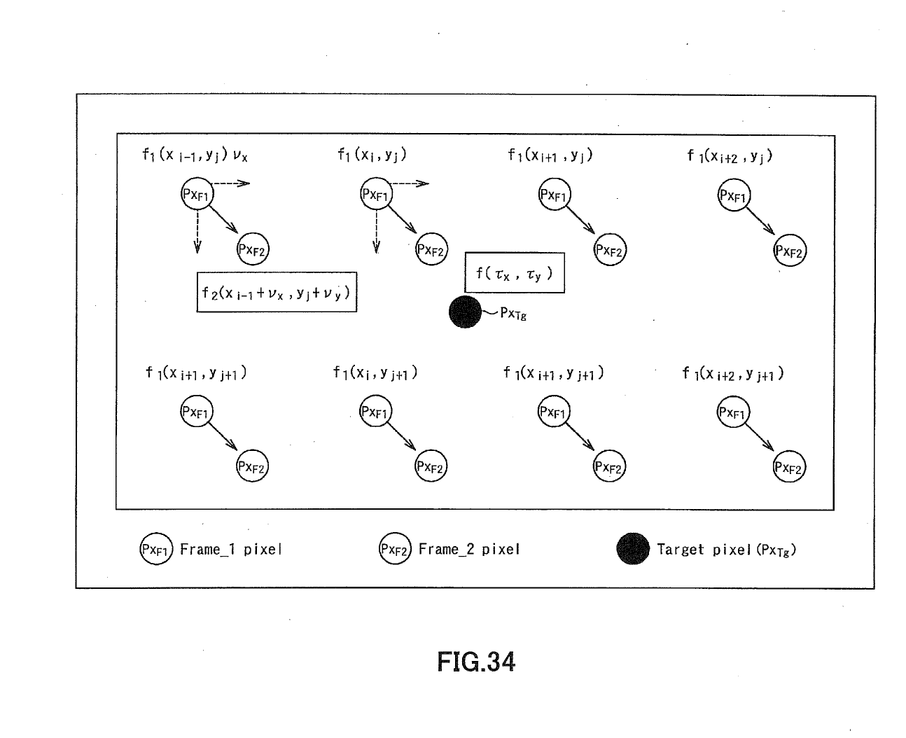

A real example of high resolution interpolation is shown in FIG. 33. A concrete example of the pixel structure for interpolation is shown in FIG. 34.

In FIG. 34, a pixel Px_{F1} of Frame_1 has a different motion vector that varies pixel Px_{F2} in Frame_2:

\hat{v}=(\hat{v}ₓ,\hat{v}_{y}) [Equation 64]

A pixel Px_{τs} is a target pixel of interpolation.

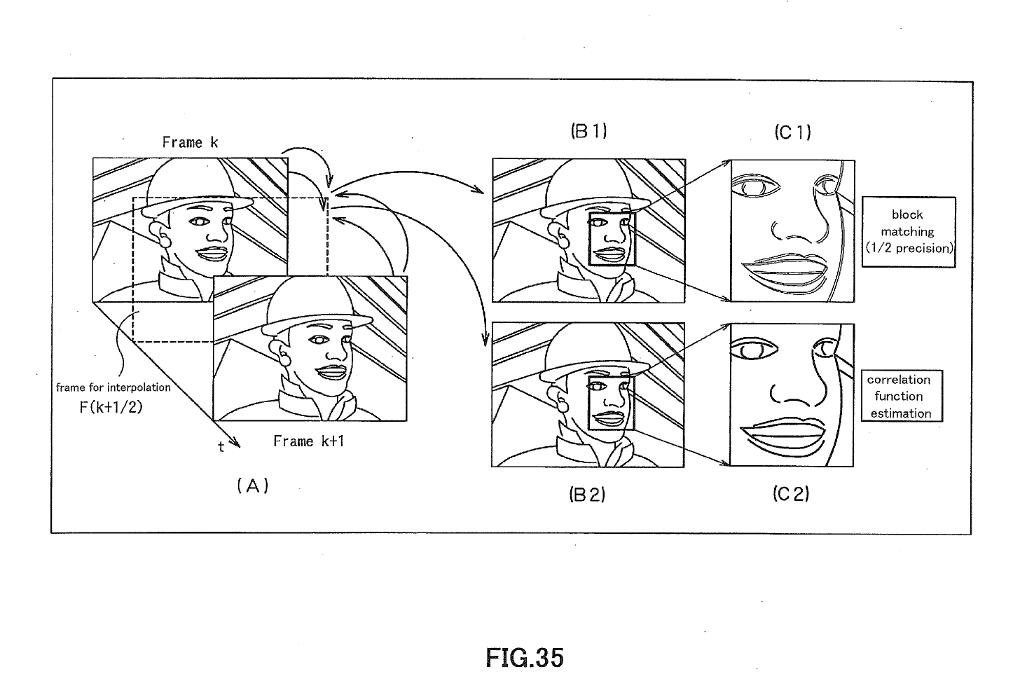

FIG. 35 shows the concept of a one-dimensional image interpolation from two consecutive frames.

Motion evaluation is by an algorithm of full-retrieval block matching whose the block size and the retrieval window size are known.

A high resolution frame pixel is represented by f (τₓ, τ_{y}). Its pixel structure is shown in an example of high resolution interpolation approach shown in FIG. 34.

In a first step, two consecutive frames are obtained from a video sequence and are expressed as f₁(x, y) and f₂(x, y).

In a second step, an initial estimation of a motion vector is made.

The initial estimation of the motion vector is made by:

$$\begin{matrix} {v}_{r} = {argmax}_{( u , v )} [ \tilde{v} ( u , v ) ] & [ Equation 65 ] \\ [ Equation 66 ] & \\ \hat{v} ( u , v ) = \frac{{\sum }_{x , y} [ {f}_{1} ( x , y ) - {\overline{f}}_{wa} ] [ {f}_{2} ( x + u , x + v ) - {\overline{f}}_{ta} ]}{{[ {\sum }_{x , y} {{[ {f}_{1} ( x , y ) - {\overline{f}}_{wa} ]}^{2} [ {f}_{2} ( x + u , x + v ) - {\overline{f}}_{ta} ]}^{2} ]}^{0.5}} & ( 18 )\end{matrix}$$

in which equation (18):

f̅_{wa} [Equation 67]

represents an average value of search windows, and

f̅ₜₐ [Equation 68]

represents an average value of current block in matching.

In a third step, for the total of the pixels that use the equations (13) and (17):

\hat{v}=(\hat{v}ₓ, v̅_{y}) [Equation 69]

a motion vector is obtained from a sole pixel in the neighborhood of the motion vector from the second step:

vᵣ [Equation 70]

In a fourth step, the uniform horizontal interpolation is executed as follows:

$$\begin{matrix}[ Equation 71 ] & \\ \begin{matrix}{f}_{1} ( {τ}_{x} , {y}_{j} ) = {\sum }_{i = 1}^{4} {f}_{1} ( {x}_{i} , {y}_{j} ) {h}_{f} ( {τ}_{x} - {x}_{i} ) ( j = 1 , 2 ) \\ {f}_{2} ( {τ}_{x} , {y}_{j} - {\hat{v}}_{y} ) = {\sum }_{i = 1}^{4} {f}_{2} ( {x}_{i} - {\hat{v}}_{x} , {y}_{j} - {\hat{v}}_{y} ) \times {h}_{f} ( {τ}_{x} - {x}_{i} + {\hat{v}}_{x} ) \\ ( j = 1 , 2 )\end{matrix} & ( 19 )\end{matrix}$$

In a fifth step, the non-uniform vertical interpolation that uses the pixel obtained in the fourth step is executed in accordance with the equation (20):

$$\begin{matrix} [ Equation 72 ] & \\ f ( {τ}_{x} , {τ}_{y} ) = {\sum }_{j = 1}^{2} {f}_{1} ( {τ}_{x} , {y}_{j} ) {h}_{n} ( {τ}_{y} - {y}_{j} ) + {\sum }_{j = 1}^{2} {f}_{2} ( {τ}_{x} , {y}_{j} - {v}_{y} ) {h}_{n} ( {τ}_{y} - {y}_{j} + {v}_{y} ) & ( 20 )\end{matrix}$$

The fourth and fifth steps are repeated with a high resolution for the total of the pixels.

In the encoding of moving pictures, which is based on the fluency theory, a signal space suited to the original signal is selected and render-into-function processing is carried out thereon, so that high compression may be accomplished as sharpness is maintained.

The function space, to which belongs the frame-to-frame correlation function, is accurately determined, whereby the motion vector may be found to optional precision.

In the encoding of moving pictures, which is based on the fluency function, a signal space suited to the original signal is selected and render-into-function processing is carried out, whereby high compression may be accomplished as sharpness is maintained.

The frame-to-frame corresponding points are traced and temporal transitions thereof are expressed in the form of the function, such as to generate a frame for interpolation, expressed by a function, based on the number ratio of the original frame and frames for conversion. By so doing, a clear picture signal with smooth motion may be obtained at a frame rate suited to a display unit.

Suppose that a frame is to be generated at an optional time point between a frame k and a frame k+1, as shown in FIG. 35(A), and that, in this case, a frame for interpolation F(k+½) is generated by uniform interpolation to find the motion information by ½ precision motion estimation, as conventionally. Also suppose that, using the motion information, thus obtained, the gray scale value of a corresponding point is generated by ½ precision by block matching, again as conventionally, by way of performing the frame rate enhancing processing. In this case, a picture of the frame for interpolation introduced undergoes deterioration in picture quality in the moving picture portion, as shown in FIG. 35 (B1) and (C1). However, in the frame rate enhancing processing, performed using the frame rate enhancing unit 40, gray scale values of the corresponding points of the interpolated frames are generated by uniform interpolation from the gray scale values of the corresponding points as estimated by the processing of corresponding point estimation. The gray scale values of the corresponding points of the interpolated frames are then found by non-uniform interpolation. Hence, the frame rate may be enhanced without the moving picture portion undergoing deterioration in picture quality, as shown in FIG. 35 (B2), (C2).

In the present picture signal conversion system 100, the input picture information at the picture input unit 10, such as picture pickup device, is freed of noise by the pre-processor 20. The picture information thus freed of noise by the pre-processor 20 is encoded for compression by the compression encoding processor 30. The frame rate enhancing unit 40 traces the frame-to-frame corresponding points. The frame rate enhancing unit then expresses the temporal transitions thereof by a function to generate a frame for interpolation, by a function, based on the number ratio of the original frame and the frames for conversion. By so doing, the picture information encoded for compression by the compression encoding processor 30 is enhanced in its frame rate, thus generating a clear picture signal showing a smooth movement.

1. A picture signal conversion system comprising:
a pre-processor having a reverse filter operating for performing pre-processing of removing blurring or noise contained in an input picture signal; the pre-processor including an input picture observation model that adds noise n(x,y) to an output of a blurring function H(x,y) to output an observed model g(x,y), the blurring function inputting a true picture f(x,y) to output a deteriorated picture; the pre-processor recursively optimizing the blurring function H(x,y) so that the input picture signal will be coincident with the observed picture; the reverse filter extracting a true picture signal from the input picture signal;
an encoding processor performing corresponding point estimation, based on a fluency theory, on the true input picture signal freed of noise by the pre-processor; expressing the motion information of a picture in the form of a function; the encoding processor selecting a signal space for the true input picture signal; expressing the picture information for the input picture signal from one selected signal space to another, and stating, in a preset form, the picture motion information expressed in the form of a function and the signal-space-based picture information expressed as the function to encode the picture signal by compression; and
a frame rate enhancing processor for enhancing the frame rate of the picture signal encoded for compression by the encoding processor.

2. The picture signal conversion system according to claim 1, wherein the encoding processor comprises
a corresponding point estimation unit for performing corresponding point estimation on the input picture signal freed of noise by the pre-processor, based on the fluency theory;
a first render-into-function processor for expressing the picture movement information in the form of a function based on the result of estimation of the corresponding point information by the corresponding point estimation unit;
a second render-into-function processor for selecting a plurality of signal spaces for the input picture signal and for rendering the picture information in the form of a function from one signal space selected to another; and
an encoding processor that states, in a preset form, the picture movement information expressed in the form of the function by the first render-into-function processor, and the signal-space-based picture information expressed as a function by the second render-into-function to encode the input picture signal by compression.

3. The picture signal conversion system according to claim 2, wherein the corresponding point estimation unit comprises:
first partial region extraction means for extracting a partial region of a frame picture;
second partial region extraction means for extracting a partial region of another frame picture similar in shape to the partial region extracted by the first partial region extraction means;
approximate-by-function means for selecting the partial regions extracted by the first and second partial region extraction means so that the selected partial regions will have equivalent picture states; the approximate-by-function means expressing the gray levels of the selected partial regions by piece-wise polynomials to output the piece-wise polynomials;
correlation value calculation means for calculating correlation values of outputs of the approximate-by-function means; and
offset value calculation means for calculating the position offset of the partial regions that will give a maximum value of the correlation calculated by the correlation value calculation means to output the calculated values as the offset values of the corresponding points.

4. The picture signal conversion system according to claim 1, wherein
the second render-into-function processor includes
an automatic region classification processor that selects a plurality of signal spaces, based on the fluency theory, for the picture signal freed of noise by the pre-processing; and a render-into-function processing section that renders the picture information into a function from one signal space selected by the automatic region classification processor to another;
the render-into-function processing section including a render-gray-level-into-function processor that, for a region that has been selected by the automatic region classification processor and that is expressible by a polynomial, approximates the picture gray level by approximation with a surface function to put the gray level information into a function, and
a render-contour-line-into-function processor that, for the region that has been selected by the automatic region classification processor and that is expressible by a polynomial, approximates the picture contour line by approximation with the picture contour line function to render the contour line into the form of a function.

5. The picture signal conversion system according to claim 4, wherein
the render-gray-level-into-function processor puts the gray level information, for the picture information of the piece-wise plane information (m≦2), piece-wise curved surface information (m=3) and the piece-wise spherical surface information (m=∞), selected by the automatic region classification processor and expressible by a polynomial, using a fluency function.

6. The picture signal conversion system according to claim 4, wherein the render-contour-line-into-function processor includes an automatic contour classification processor that extracts and classifies the piece-wise line segment, piece-wise degree-two curve and piece-wise arc from the picture information selected by the automatic region classification processor; the render-contour-line-into-function approximating the piece-wise line segment, piece-wise degree-two curve and piece-wise arc, classified by the render-contour-line-into-function processor, using fluency functions, to put the contour information into the form of a function.

7. The picture signal conversion system according to claim 1, wherein
the frame rate enhancing unit includes
a corresponding point estimation processor that, for each of a plurality of pixels in a reference frame, estimates a corresponding point in each of a plurality of picture frames differing in time;
a first processor of gray scale value generation that, for each of the corresponding points in each picture frame estimated, finds the gray scale value of each corresponding point from gray scale values indicating the gray level of neighboring pixels;
a second processor of gray scale value generation that approximates, for each of the pixels in the reference frame, from the gray scale values of the corresponding points in the picture frames estimated, the gray scale value of the locus of the corresponding points by a fluency function, and of finding, from the function, the gray scale values of the corresponding points of a frame for interpolation; and
a third processor of gray scale value generation that generates, from the gray scale value of each corresponding point in the picture frame for interpolation, the gray scale value of neighboring pixels of each corresponding point in the frame for interpolation.

8. The picture signal conversion system according to claim 1, wherein
the frame rate enhancing processor performs, for the picture signal encoded for compression by the encoding processor, the processing of enhancing the frame rate as well as size conversion of enlarging or reducing the picture to a predetermined size, based on the picture information and the motion information put into the form of the functions.

9. The picture signal conversion system according to claim 1, wherein
the frame rate enhancing unit includes
first function approximation means for inputting the picture information, encoded for compression by the encoding processor and for approximating the gray scale distribution of a plurality of pixels in reference frames by a function;
corresponding point estimation means for performing correlation calculations, using a function of gray scale distribution in a plurality of the reference frames differing in time, approximated by the first approximate-by-function unit, to set respective positions that yield the maximum value of the correlation as the corresponding point positions in the respective reference frames;
second function approximation means for putting corresponding point positions in each reference frame as estimated by the corresponding point estimation unit into the form of coordinates in terms of the horizontal and vertical distances from the point of origin of each reference frame, putting changes in the horizontal and vertical positions of the coordinate points in the reference frames, different in time, into time-series signals, and approximating the time-series signals of the reference frames by a function; and
third function approximation means for setting, for a picture frame of interpolation at an optional time point between the reference frames, a position in the picture frame for interpolation corresponding to the corresponding point positions in the reference frames, as a corresponding point position, based on the function approximated by the second approximate-by-function unit; the third approximate-by-function unit finding a gray scale value at the corresponding point position of the picture frame for interpolation by interpolation with gray scale values at the corresponding points of the reference frames; the third approximate-by-function unit causing the first function approximation to fit with the gray scale value of the corresponding point of the picture frame for interpolation to find the gray scale distribution in the neighborhood of the corresponding point to convert the gray scale distribution in the neighborhood of the corresponding point into the gray scale values of the pixel points in the picture frame for interpolation.

10. The picture signal conversion system according to claim 1, wherein
if f(x,y)*f(x,y) is representatively expressed as Hf, from the result of singular value decomposition (SVD) on an observed picture g(x,y) and a blurring function of a deterioration model,
the reverse filter in the pre-processor possesses filter characteristics obtained on learning of repeatedly performing the processing of;
setting a system equation as
g=f+n=Hf+n [Equation 1]
setting
H=A [symbol] B
(A [symbol] B)f=vec(BFA^{T}), vec(F)=f [Equation 2]
where [symbol]
[Equation 3]
denotes a Kronecker operator, and
vec [Equation 4]
is an operator that extends a matrix in the column direction to generate a column vector); to approximate f; calculating a new target picture g_{E} as
g_{E}=(βC_{EP}+γC_{EN})g [Equation 5]
(where β and γ are control parameters and C_{EP}, C_{EN} are respectively operators for edge saving and edge emphasis); and as
g_{KPA}=vec(BG_{E}A^{T}), vec(G_{E})=g_{E} [Equation 6]
performing minimizing processing
$${min}_{f} \{ {‖ {H}_{k} f - {g}_{KPA} ‖}^{2} + α {‖ Cf ‖}^{2} \} \qquad [ Equation 7 ]$$
on the new picture calculated g_{KPA}; verifying whether or not fₖ obtained meets the test condition; if the test condition is not met, performing minimizing processing:
$${min}_{H} \{ {‖ {Hf}_{k} - {g}_{KPA} ‖}^{2} \} \qquad [ Equation 8 ]$$
on the blurring function HK of the deterioration model; and estimating the blurring function H of the deterioration model:
G_{SVD}=UΣV^{T}, A=U_{A}Σ_{A}V_{A}^{T}, B=U_{B}Σ_{B}V_{B}^{T} [Equation 9]
as
H=(U_{A} [symbol] U_{B})(Σ_{A} [symbol] Σ_{B})(V_{A} [symbol] V_{B})^{T} [Equation 10]
until fₖ obtained by the minimizing processing on the new picture g_{KPA} meets the test condition.

11. The picture signal conversion system according to claim 10, wherein the processing for learning verifies whether or not, on fₖ obtained by the minimizing processing on the new picture calculated g_{KPA}, the test condition:
∥Hₖfᵢ−g_{KPA}∥²+α∥Cfₖ∥²<ε², k>c
where k is the number of times of repetition and ε, c denote threshold values for decision, is met.

12. The picture signal conversion system according to claim 2, wherein
the second render-into-function processor includes
an automatic region classification processor that selects a plurality of signal spaces, based on the fluency theory, for the picture signal freed of noise by the pre-processing; and a render-into-function processing section that renders the picture information into a function from one signal space selected by the automatic region classification processor to another;
the render-into-function processing section including a render-gray-level-into-function processor that, for a region that has been selected by the automatic region classification processor and that is expressible by a polynomial, approximates the picture gray level by approximation with a surface function to put the gray level information into a function, and
a render-contour-line-into-function processor that, for the region that has been selected by the automatic region classification processor and that is expressible by a polynomial, approximates the picture contour line by approximation with the picture contour line function to render the contour line into the form of a function.

13. The picture signal conversion system according to claim 3, wherein
the second render-into-function processor includes
an automatic region classification processor that selects a plurality of signal spaces, based on the fluency theory, for the picture signal freed of noise by the pre-processing; and a render-into-function processing section that renders the picture information into a function from one signal space selected by the automatic region classification processor to another;
the render-into-function processing section including a render-gray-level-into-function processor that, for a region that has been selected by the automatic region classification processor and that is expressible by a polynomial, approximates the picture gray level by approximation with a surface function to put the gray level information into a function, and
a render-contour-line-into-function processor that, for the region that has been selected by the automatic region classification processor and that is expressible by a polynomial, approximates the picture contour line by approximation with the picture contour line function to render the contour line into the form of a function.

14. The picture signal conversion system according to claim 2, wherein
the frame rate enhancing unit includes
a corresponding point estimation processor that, for each of a plurality of pixels in a reference frame, estimates a corresponding point in each of a plurality of picture frames differing in time;
a first processor of gray scale value generation that, for each of the corresponding points in each picture frame estimated, finds the gray scale value of each corresponding point from gray scale values indicating the gray level of neighboring pixels;
a second processor of gray scale value generation that approximates, for each of the pixels in the reference frame, from the gray scale values of the corresponding points in the picture frames estimated, the gray scale value of the locus of the corresponding points by a fluency function, and of finding, from the function, the gray scale values of the corresponding points of a frame for interpolation; and
a third processor of gray scale value generation that generates, from the gray scale value of each corresponding point in the picture frame for interpolation, the gray scale value of neighboring pixels of each corresponding point in the frame for interpolation.

15. The picture signal conversion system according to claim 3, wherein
the frame rate enhancing unit includes
a corresponding point estimation processor that, for each of a plurality of pixels in a reference frame, estimates a corresponding point in each of a plurality of picture frames differing in time;
a first processor of gray scale value generation that, for each of the corresponding points in each picture frame estimated, finds the gray scale value of each corresponding point from gray scale values indicating the gray level of neighboring pixels;
a second processor of gray scale value generation that approximates, for each of the pixels in the reference frame, from the gray scale values of the corresponding points in the picture frames estimated, the gray scale value of the locus of the corresponding points by a fluency function, and of finding, from the function, the gray scale values of the corresponding points of a frame for interpolation; and
a third processor of gray scale value generation that generates, from the gray scale value of each corresponding point in the picture frame for interpolation, the gray scale value of neighboring pixels of each corresponding point in the frame for interpolation.

16. The picture signal conversion system according to claim 2, wherein
the frame rate enhancing processor performs, for the picture signal encoded for compression by the encoding processor, the processing of enhancing the frame rate as well as size conversion of enlarging or reducing the picture to a predetermined size, based on the picture information and the motion information put into the form of the functions.

17. The picture signal conversion system according to claim 3, wherein
the frame rate enhancing processor performs, for the picture signal encoded for compression by the encoding processor, the processing of enhancing the frame rate as well as size conversion of enlarging or reducing the picture to a predetermined size, based on the picture information and the motion information put into the form of the functions.

18. The picture signal conversion system according to claim 2, wherein
the frame rate enhancing unit includes
first function approximation means for inputting the picture information, encoded for compression by the encoding processor and for approximating the gray scale distribution of a plurality of pixels in reference frames by a function;
corresponding point estimation means for performing correlation calculations, using a function of gray scale distribution in a plurality of the reference frames differing in time, approximated by the first approximate-by-function unit, to set respective positions that yield the maximum value of the correlation as the corresponding point positions in the respective reference frames;
second function approximation means for putting corresponding point positions in each reference frame as estimated by the corresponding point estimation unit into the form of coordinates in terms of the horizontal and vertical distances from the point of origin of each reference frame, putting changes in the horizontal and vertical positions of the coordinate points in the reference frames, different in time, into time-series signals, and approximating the time-series signals of the reference frames by a function; and
third function approximation means for setting, for a picture frame of interpolation at an optional time point between the reference frames, a position in the picture frame for interpolation corresponding to the corresponding point positions in the reference frames, as a corresponding point position, based on the function approximated by the second approximate-by-function unit; the third approximate-by-function unit finding a gray scale value at the corresponding point position of the picture frame for interpolation by interpolation with gray scale values at the corresponding points of the reference frames; the third approximate-by-function unit causing the first function approximation to fit with the gray scale value of the corresponding point of the picture frame for interpolation to find the gray scale distribution in the neighborhood of the corresponding point to convert the gray scale distribution in the neighborhood of the corresponding point into the gray scale values of the pixel points in the picture frame for interpolation.

19. The picture signal conversion system according to claim 3, wherein
the frame rate enhancing unit includes
first function approximation means for inputting the picture information, encoded for compression by the encoding processor and for approximating the gray scale distribution of a plurality of pixels in reference frames by a function;
corresponding point estimation means for performing correlation calculations, using a function of gray scale distribution in a plurality of the reference frames differing in time, approximated by the first approximate-by-function unit, to set respective positions that yield the maximum value of the correlation as the corresponding point positions in the respective reference frames;
second function approximation means for putting corresponding point positions in each reference frame as estimated by the corresponding point estimation unit into the form of coordinates in terms of the horizontal and vertical distances from the point of origin of each reference frame, putting changes in the horizontal and vertical positions of the coordinate points in the reference frames, different in time, into time-series signals, and approximating the time-series signals of the reference frames by a function; and
third function approximation means for setting, for a picture frame of interpolation at an optional time point between the reference frames, a position in the picture frame for interpolation corresponding to the corresponding point positions in the reference frames, as a corresponding point position, based on the function approximated by the second approximate-by-function unit; the third approximate-by-function unit finding a gray scale value at the corresponding point position of the picture frame for interpolation by interpolation with gray scale values at the corresponding points of the reference frames; the third approximate-by-function unit causing the first function approximation to fit with the gray scale value of the corresponding point of the picture frame for interpolation to find the gray scale distribution in the neighborhood of the corresponding point to convert the gray scale distribution in the neighborhood of the corresponding point into the gray scale values of the pixel points in the picture frame for interpolation.

20. The picture signal conversion system according to claim 2, wherein
if f(x,y)*f(x,y) is representatively expressed as Hf, from the result of singular value decomposition (SVD) on an observed picture g(x,y) and a blurring function of a deterioration model,
the reverse filter in the pre-processor possesses filter characteristics obtained on learning of repeatedly performing the processing of;
setting a system equation as
g=f+n=Hf+n [Equation 1]
setting
H=A [symbol] B
(A [symbol] B)f=vec(BFA^{T}), vec(F)=f [Equation 2]
where [symbol]
[Equation 3]
denotes a Kronecker operator, and
vec [Equation 4]
is an operator that extends a matrix in the column direction to generate a column vector); to approximate f; calculating a new target picture g_{E} as
g_{E}=(βC_{EP}+γC_{EN})g [Equation 5]
(where β and γ are control parameters and C_{EP}, C_{EN} are respectively operators for edge saving and edge emphasis); and as
g_{KPA}=vec(BG_{E}A^{T}), vec(G_{E})=g_{E} [Equation 6]
performing minimizing processing
$${min}_{f} \{ {‖ {H}_{k} f - {g}_{KPA} ‖}^{2} + α {‖ Cf ‖}^{2} \} \qquad [ Equation 7 ]$$
on the new picture calculated g_{KPA}; verifying whether or not fₖ obtained meets the test condition; if the test condition is not met, performing minimizing processing:
$${min}_{H} \{ {‖ {Hf}_{k} - {g}_{KPA} ‖}^{2} \} \qquad [ Equation 8 ]$$
on the blurring function HK of the deterioration model; and estimating the blurring function H of the deterioration model:
G_{SVD}=UΣV^{T}, A=U_{A}Σ_{A}V_{A}^{T}, B=U_{B}Σ_{B}V_{B}^{T} [Equation 9]
as
H=(U_{A} [symbol] U_{B})(Σ_{A} [symbol] Σ_{B})(V_{A} [symbol] V_{B})^{T} [Equation 10]
until fₖ obtained by the minimizing processing on the new picture g_{KPA} meets the test condition.

21. The picture signal conversion system according to claim 3, wherein
if f(x,y)*f(x,y) is representatively expressed as Hf, from the result of singular value decomposition (SVD) on an observed picture g(x,y) and a blurring function of a deterioration model,
the reverse filter in the pre-processor possesses filter characteristics obtained on learning of repeatedly performing the processing of;
setting a system equation as
g=f+n=Hf+n [Equation 1]
setting
H=A [symbol] B
(A [symbol] B)f=vec(BFA^{T}), vec(F)=f [Equation 2]
where [symbol]
[Equation 3]
denotes a Kronecker operator, and
vec [Equation 4]
is an operator that extends a matrix in the column direction to generate a column vector); to approximate f; calculating a new target picture g_{E} as
g_{E}=(βC_{EP}+γC_{EN})g [Equation 5]
(where β and γ are control parameters and C_{EP}, C_{EN} are respectively operators for edge saving and edge emphasis); and as
g_{KPA}=vec(BG_{E}A^{T}), vec(G_{E})=g_{E} [Equation 6]
performing minimizing processing
$${min}_{f} \{ {‖ {H}_{k} f - {g}_{KPA} ‖}^{2} + α {‖ Cf ‖}^{2} \} \qquad [ Equation 7 ]$$
on the new picture calculated g_{KPA}; verifying whether or not fₖ obtained meets the test condition; if the test condition is not met, performing minimizing processing:
$${min}_{H} \{ {‖ {Hf}_{k} - {g}_{KPA} ‖}^{2} \} \qquad [ Equation 8 ]$$
on the blurring function HK of the deterioration model; and estimating the blurring function H of the deterioration model:
G_{SVD}=UΣV^{T}, A=U_{A}Σ_{A}V_{A}^{T}, B=U_{B}Σ_{B}V_{B}^{T} [Equation 9]
as
H=(U_{A} [symbol] U_{B})(Σ_{A} [symbol] Σ_{B}(V_{A} [symbol] V_{B})^{T} [Equation 10]
until fₖ obtained by the minimizing processing on the new picture meets the test condition.
